(19) United States
(12) Patent Application Publication
(10) Pub. No.: US 2025/0196932 A1
(43) Pub. Date: Jun. 19, 2025

(54) VEHICLE

(71) Applicant: TS TECH CO., LTD., Asaka-shi, Saitama (JP)

(72) Inventors: Hiroshi BABA, Tochigi (JP); Yoshiki EBIZUKA, Tochigi (JP); Yasuyuki ISHIKAWA, Tochigi (JP); Kei MIYAMOTO, Tochigi (JP); Yuki HOSOKAWA, Tochigi (JP); Shintaro MOCHIZUKI, Tochigi (JP)

(21) Appl. No.: 18/849,806

(22) PCT Filed: Mar. 6, 2023
(86) PCT No.: PCT/JP2023/008412

§ 371 Date: Sep. 23, 2024

(30) Foreign Application Priority Data
Mar. 23, 2022 (JP) 2022-047427
Apr. 1, 2022 (JP) 2022-061977
Apr. 1, 2022 (JP) 2022-061978
Apr. 1, 2022 (JP) 2022-061979

(51) Int. Cl. B62D 25/20; B60K 1/04; B60N 2/02

(52) U.S. Cl. CPC B62D 25/20; B60K 1/04; B60N 2/0256; B60K 2001/0438

(57) ABSTRACT

A vehicle having improved foot entry is provided. In a vehicle equipped with a floor, a first seat disposed on the floor, and a second seat disposed behind the first seat, the vehicle includes a concave portion which is formed in a floor to include at least a region on the floor located behind the first seat and to place feet of a seated occupant sitting on the second seat. Since the concave portion is formed, a foot entry space of a seated occupant sitting on the second seat at the rear is expanded and the foot entry is improved.

### TECHNICAL FIELD

The present invention relates to a vehicle and more particularly to a vehicle having a seat which is disposed on a floor so that an occupant sits thereon.

### BACKGROUND ART

In an electric vehicle (EV vehicle), batteries are arranged below a vehicle floor and in order to accommodate more batteries, a floor surface is made higher to ensure a space for batteries. In order to maintain the driver's eye point while raising the floor surface without changing the position of a vehicle ceiling, the seat height needs to be lowered. Therefore, the space between the seat cushion and the floor in the electric vehicle can be narrower than in an engine vehicle.

On the other hand, an occupant sitting on a rear seat may want to take a relaxed posture of stretching out the feet by entering the feet below the front seat. However, since the space between the seat cushion and the floor is narrow due to the above-described reason, it is difficult to stretch out the feet and to enter the feet below the seat cushion compared to the engine vehicle.

In the vehicle seat described in Patent Literature 1, since upper rails arranged on the right and left sides of a seat rail device are connected by a seat support member to be integrated, the feet entered the space below the seat cushion are easily stretched in the right to left direction and hence the foot entry is improved.

### CITATION LIST

### Patent Literature

PATENT LITERATURE 1: Japanese Patent Application Laid-Open No. 2020-59420

### SUMMARY OF INVENTION

### Technical Problem

However, since the vehicle seat described in Patent Literature 1 is disposed on the flat vehicle floor, the space below the seat cushion is narrow in the height direction and hence there is a limit when making a foot entry space by modifying the structure of the vehicle seat.

The present invention has been made in view of the above-described problems and an object thereof is to provide a vehicle that improves foot entry so that a space for placing feet of a seated occupant is expanded more.

### Solution to Problem

According to the vehicle of the present invention, the above-described problems are solved by a vehicle equipped with a floor, a first seat disposed on the floor, and a second seat disposed behind the first seat, including: a concave portion which is formed in the floor to include at least a region located behind the first seat and to place feet of a seated occupant sitting on the second seat.

Since the concave portion is formed to include at least the region on the floor located behind the first seat, the foot entry space of the seated occupant sitting on the second seat is expanded downward and hence the vehicle having improved foot entry can be provided.

In the vehicle, the concave portion may have a triangular cross section.

Since the concave portion has a triangular cross section, the space for placing the feet of the seated occupant can be expanded while ensuring the space below the floor and hence the foot entry is improved.

Further, the vehicle may further include a pair of slide rails which are attached so that the first seat is slidable on the floor, and the concave portion may be formed at a position behind rear ends of the pair of slide rails.

Since the concave portion is formed at a position behind the rear ends of the pair of slide rails, the foot entry can be improved while having a simple shape of the floor.

Further, the vehicle may further include a pair of slide rails which are attached so that the first seat is slidable on the floor, and the concave portion may be formed between the pair of slide rails to include a region located in front of rear ends of the pair of slide rails.

Since the concave portion includes a region located in front of the rear end of the slide rail, the feet can be entered below the seat cushion and hence the foot entry can be further improved.

Further, the vehicle may further include a pair of slide rails which are attached so that the first seat is slidable on the floor, and the concave portion may be formed between the pair of slide rails to include a region continuously extending from the front to the rear of the pair of slide rails.

Since the concave portion includes a region continuously extending from the front to the rear of the slide rail, the feet can be stretched below the seat cushion and hence the foot entry can be further improved.

Further, the vehicle may further include a beam member that extends in a right to left direction of the vehicle below the floor and supports the floor, and the concave portion may be formed at a position avoiding the beam member.

Since the concave portion is formed at a position avoiding the beam member provided below the floor, that is, a region in which the beam member below the floor is not disposed, the foot entry can be improved by forming the concave portion without affecting the beam member.

Further, the vehicle may further include a beam member that extends in a right to left direction of the vehicle on the floor and supports the floor and the concave portion may be formed at a position avoiding the beam member.

Since the concave portion is formed at a position avoiding the beam member provided on the floor, that is, the concave portion is formed in a region in which the beam member on the floor is not disposed, the foot entry can be improved by forming the concave portion without affecting the beam member.

Further, in the vehicle, the floor may have an opening portion formed in a region located below the first seat, the floor may have a lid portion that closes the opening portion, and the concave portion may be formed at a position avoiding the lid portion.

Since the concave portion is formed at a position avoiding the lid portion that closes the opening portion of the floor, that is, a region in which the lid portion is not disposed, the foot entry can be improved by forming the concave portion without affecting the lid portion.

Further, the vehicle may further include a battery which is disposed below the floor and a member that is disposed on the battery between the floor and the battery, and the concave portion may be formed at a position avoiding a member disposed on the battery.

Since the concave portion is formed at a position avoiding a member disposed on the battery, for example, a shock absorbing portion or the like, that is, a region in which the shock absorbing portion or the like is not disposed, the foot entry can be improved by forming the concave portion without affecting the member disposed on the battery.

Further, in the vehicle, a foot cover may be provided at each of rear ends of the pair of slide rails of the first seat, and the foot cover may have an inclined surface inclined downward as it goes toward the rear of the vehicle.

Since the foot cover has the inclined surface, the inclined surface of the foot cover and the concave portion formed in the floor are integrated and hence the feet can be easily placed.

Further, in the vehicle, the foot cover may be integrally formed across the rear ends of the pair of slide rails, and the inclined surface of the foot cover may extend to the concave portion formed in the floor.

Since the inclined surface of the foot cover extends to the concave portion, the feet can be more easily placed behind the first seat.

Further, in the vehicle, the first seat may include a seat cushion on which an occupant sits and an entry suppressing portion which is disposed between a region on a rear end side of the seat cushion and the floor and suppresses a foreign object from behind the first seat from entering between the seat cushion and the floor.

Since the first seat includes the entry suppressing portion provided between the region on the rear end side of the seat cushion and the floor, a foreign object, for example, an occupant's foot or luggage is suppressed from entering below the seat cushion. Accordingly, for example, damage to the bottom surface of the seat cushion or electrical components arranged at the lower side can be reduced.

Further, in the vehicle, the first seat may be a conveyance seat equipped with a seat cushion on which an occupant sits, the seat cushion may include a plate-shaped pressure receiving member that receives a load of the occupant and a harness member that is fixed to the pressure receiving member, and at least a part of the harness member may be disposed in a center region in a right to left direction on a rear end side of the pressure receiving member.

The feet of the occupant sitting on the rear seat are inserted to be biased to either the right or left side from behind the first seat. Therefore, the possibility that the feet can enter the center region of the seat is less than the right and left regions. Conventionally, since the harness member disposed in either the right or left region on the rear end side of the pressure receiving member is disposed in the center region in the right to left direction, the harness member is suppressed from being kicked by the feet of the occupant.

Further, in the vehicle, the first seat may be an electric conveyance seat including a seat body attached at a predetermined height position from the conveyance floor and forming a space between the seat body and the floor, a drive mechanism driving the seat body to move, and control means controlling the drive mechanism, and the control means may acquire a detection signal of an entry object entering the space and control the drive mechanism so that the seat body is separated from the entry object based on the detection signal.

According to the above-described configuration, when the entry object entering the space between the seat body and the floor is detected, the seat body is driven and controlled to be separated from the entry object. Therefore, for example, when the feet of the seated occupant sitting on the rear seat enter the space between the seat body and the floor, the first seat in the front row is driven upward or forward to be separated from the feet. Accordingly, the foot space of the seated occupant sitting on the rear seat is expanded and hence the limited lower space can be effectively used.

### Advantageous Effects of Invention

According to the present invention, since the concave portion is formed to include at least the region on the floor located behind the first seat, the foot entry space of the seated occupant sitting on the second seat is expanded downward and hence the vehicle having improved foot entry can be provided.

Further, according to the present invention, since the concave portion has a triangular cross section, the space for placing the feet of the seated occupant can be expanded while ensuring the space below the floor and hence the foot entry is improved.

Further, according to the present invention, since the concave portion is formed at a position behind the rear ends of the pair of slide rails, the foot entry can be improved while having a simple shape of the floor.

Further, according to the present invention, since the concave portion includes a region located in front of the rear end of the slide rail, the feet can be entered below the seat cushion and hence the foot entry can be further improved.

Further, according to the present invention, since the concave portion includes a region continuously extending from the front to the rear of the slide rail, the feet can be stretched below the seat cushion and hence the foot entry can be further improved.

Further, according to the present invention, since the concave portion is formed at a position avoiding the beam member provided below the floor, that is, a region in which the beam member below the floor is not disposed, the foot entry can be improved by forming the concave portion without affecting the beam member.

Further, according to the present invention, since the concave portion is formed at a position avoiding the beam member provided on the floor, that is, the concave portion is formed in a region in which the beam member on the floor is not disposed, the foot entry can be improved by forming the concave portion without affecting the beam member.

Further, according to the present invention, since the concave portion is formed at a position avoiding the lid portion that closes the opening portion of the floor, that is, a region in which the lid portion is not disposed, the foot entry can be improved by forming the concave portion without affecting the lid portion.

Further, according to the present invention, since the concave portion is formed at a position avoiding a member disposed on the battery, for example, a shock absorbing portion or the like, that is, a region in which the shock absorbing portion or the like is not disposed, the foot entry can be improved by forming the concave portion without affecting the member disposed on the battery.

Further, according to the present invention, since the foot cover has the inclined surface, the inclined surface of the foot cover and the concave portion formed in the floor are integrated and hence the feet can be easily placed.

Further, according to the present invention, since the inclined surface of the foot cover extends to the concave portion, the feet can be more easily placed behind the first seat.

Further, according to the present invention, since the first seat includes the entry suppressing portion provided between the region on the rear end side of the seat cushion and the floor, a foreign object, for example, an occupant's foot or luggage is suppressed from entering below the seat cushion. Accordingly, for example, damage to the bottom surface of the seat cushion or electrical components arranged at the lower side can be reduced.

Further, according to the present invention, the feet of the occupant sitting on the rear seat are inserted to be biased to either the right or left side from behind the first seat. Therefore, the possibility that the feet can enter the center region of the seat is less than the right and left regions. Conventionally, since the harness member disposed in either right or left region on the rear end side of the pressure receiving member is disposed in the center region in the right to left direction, the harness member is suppressed from being kicked by the feet of the occupant.

Further, according to the present invention, when the entry object entering the space between the seat body and the floor is detected, the seat body is driven and controlled to be separated from the entry object. Therefore, for example, when the feet of the seated occupant sitting on the rear seat enter the space between the seat body and the floor, the first seat in the front row is driven upward or forward to be separated from the feet. Accordingly, the foot space of the seated occupant sitting on the rear seat is expanded and hence the limited lower space can be effectively used.

### BRIEF DESCRIPTION OF DRAWINGS

FIG. 1 is a diagram showing a vehicle according to a first embodiment.

FIG. 2 is a perspective view showing the appearance of a vehicle seat mounted on the vehicle and a floor as viewed obliquely from the rear.

FIG. 3 is a perspective view showing a seat frame of the vehicle seat as viewed obliquely from the front.

FIG. 4 is a cross-sectional view taken along a line A-A of FIG. 2 and showing a concave portion formed in the floor.

FIG. 5A is a diagram showing another example of the concave portion formed in the floor.

FIG. 5B is a plan view showing the concave portion in FIG. 5A.

FIG. 6A is a diagram showing still another example of the concave portion formed in the floor.

FIG. 6B is a plan view showing the concave portion in FIG. 6A.

FIG. 7A is a diagram showing the concave portion formed at a position avoiding a cross member on the floor.

FIG. 7B is a rear view showing the cross member having a recess portion.

FIG. 8 is a diagram showing the concave portion formed at a position avoiding a lid portion of the floor.

FIG. 9 is a diagram showing the concave portion formed at a position avoiding a shock absorbing member disposed on a battery.

FIG. 10A is an enlarged view showing an inclined surface formed on a foot cover.

FIG. 10B is a perspective view showing the inclined surface formed on the foot cover.

FIG. 11A is a diagram showing an example in which the inclined surface of the foot cover is extended to the concave portion.

FIG. 11B is a perspective view showing an example in which the inclined surface of the foot cover is extended to the concave portion.

FIG. 12 is a diagram showing a vehicle equipped with a vehicle seat according to a second embodiment.

FIG. 13 is a perspective view showing the appearance of the vehicle seat as viewed obliquely from the rear.

FIG. 14 is a perspective view showing a seat frame of the vehicle seat as viewed obliquely from the front.

FIG. 15A is a cross-sectional view taken along a line A-A of FIG. 13 and showing an entry suppressing portion provided below a seat cushion.

FIG. 15B is a bottom view showing the vehicle seat as viewed from below.

FIG. 15C is a diagram showing another example of the entry suppressing portion formed integrally with a pressure receiving member.

FIG. 16A is a diagram showing another example of the entry suppressing portion.

FIG. 16B is a perspective view showing the entry suppressing portion shown in FIG. 16A.

FIG. 17A is a perspective view showing a back pocket provided on a rear surface of a seat back.

FIG. 17B is a perspective view showing a state in which the back pocket is deployed and used as an entry suppressing portion.

FIG. 18 is a configuration diagram showing an entry suppressing portion using a cover of the seat back.

FIG. 19 is a cross-sectional view showing an entry suppressing portion using a protrusion protruding from a floor.

FIG. 20 is a perspective view showing an entry suppressing portion formed by connecting a side cover.

FIG. 21 is a perspective view showing the appearance of a vehicle seat according to a third embodiment as viewed obliquely from the rear.

FIG. 22 is a perspective view showing a frame of the vehicle seat as viewed obliquely from the front.

FIG. 23 is a bottom view showing a frame of the vehicle seat as viewed from below.

FIG. 24 is a rear view showing a part of the frame of the vehicle seat as viewed from the rear.

FIG. 25A is a cross-sectional view taken along a line A-A of FIG. 23 and showing a harness clip and a harness member arranged to avoid a wire of a pressure receiving member.

FIG. 25B is an enlarged view showing a part B of FIG. 25A and showing a concave portion formed in the pressure receiving member.

FIG. 26A is a cross-sectional view taken along a line C-C of FIG. 21 and a schematic configuration diagram showing a position of a buffer material disposed behind the pressure receiving member.

FIG. 26B is a schematic configuration diagram showing another example of the buffer material.

FIG. 27 is a diagram showing the harness member disposed on an upper surface side of the pressure receiving member.

FIG. 28 is a diagram showing a wiring state of a conventional harness member.

FIG. 29 is a diagram illustrating a basic configuration of the vehicle seat and a lower space.

FIG. 30 is a perspective view of a seat frame serving as a framework of the vehicle seat.

FIG. 31A is a cross-sectional view taken along a line A-A of FIG. 29 and showing a state in which the vehicle seat is located at a lowered position.

FIG. 31B is a cross-sectional view taken along a line A-A of FIG. 29 and showing a state in which the vehicle seat is located at a raised position.

FIG. 32 is a diagram showing a functional configuration of the vehicle seat.

FIG. 33 is a diagram illustrating an attachment position of an entry detection sensor.

FIG. 34 is a diagram showing a state in which a rear link has rotated.

FIG. 35 is a diagram showing a functional configuration of a vehicle seat according to a second example of a fourth embodiment.

FIG. 36 is a diagram showing a state in which the vehicle seat is slid forward.

FIG. 37 is a diagram showing a functional configuration of a vehicle seat according to a third example of the fourth embodiment.

FIG. 38 is a diagram illustrating an attachment position of a contact sensor according to a fourth example of the fourth embodiment.

FIG. 39 is a diagram illustrating an electric vehicle in which a secondary battery is disposed below a floor.

### DESCRIPTION OF EMBODIMENTS

### First Embodiment

Hereinafter, a vehicle according to a first embodiment of the present invention and in particular, a floor structure of the vehicle will be described with reference to the drawings. However, the embodiments described below are intended to facilitate understanding of the present invention and are not intended to limit the present invention. In other words, the present invention can be modified or improved without departing from the spirit of the invention, and it goes without saying that the present invention includes equivalents thereof.

In the following description, the contents regarding the materials, shapes, and sizes of the components are merely examples and do not limit the present invention.

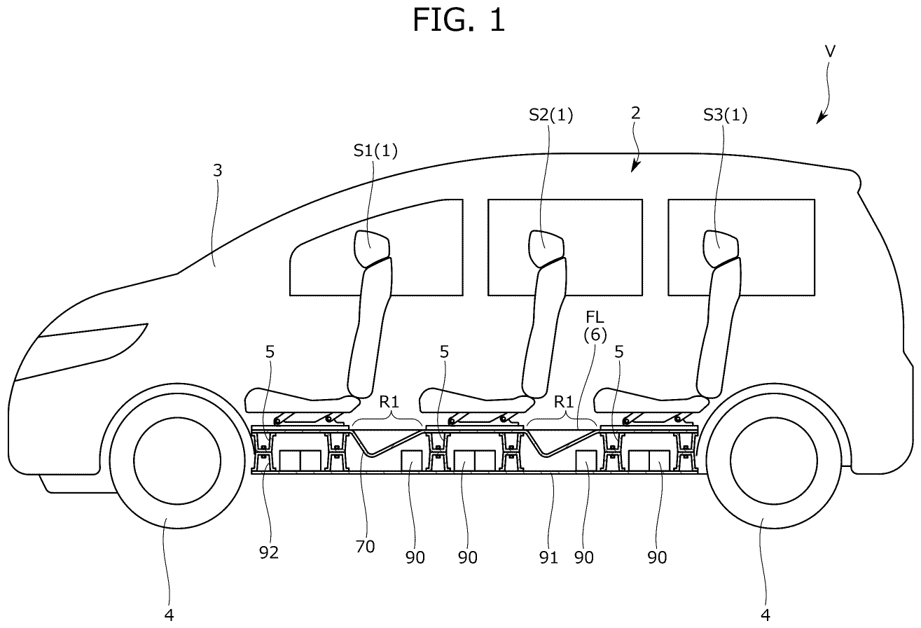

Furthermore, in the following description, a four-wheeled electric vehicle (EV vehicle) V shown in FIG. 1 having four wheels will be taken as an example of a vehicle and a configuration example of the vehicle will be described.

However, the vehicle V to which the invention is applied is not limited to the four-wheeled electric vehicle, but the invention may also be applied to an engine vehicle, a hybrid vehicle equipped with both a motor and an engine for driving, a vehicle equipped with a battery and a fuel cell as a power source, and the like.

Further, in the following description, the “front to rear direction” refers to the front to rear direction of the vehicle and the vehicle seat, and corresponds to the direction that coincides with the traveling direction when the vehicle is traveling. Further, the “right to left direction” or the “vehicle width direction” refers to the width direction of the vehicle, and corresponds to the direction that coincides with the right to left direction as viewed from an occupant sitting on the vehicle seat. Further, the “up to down direction” refers to the up to down direction of the vehicle, and corresponds to the direction that coincides with the vertical direction when the vehicle is traveling on a horizontal plane. Further, when simply referring to the “outside”, it refers to the side closer to the outside in the direction from the center of the vehicle to the outside, and when referring to the “inside”, it refers to the side closer to the center in the direction from the outside to the center of the vehicle.

Furthermore, the shape, position, posture, and the like of each part of the vehicle seat provided in the vehicle described below will be described assuming that the vehicle seat is in a seated state unless otherwise specified.

### <Basic Configuration of Vehicle V>

As shown in FIG. 1, the vehicle V to which the present invention is applied has a vehicle structure including a vehicle body 3 that defines a vehicle compartment 2 and four wheels 4 which are a pair of front wheels and a pair of rear wheels on the right and left.

The vehicle body 3 includes a pair of right and left side members (not shown) that extend in the front to rear direction of the vehicle, a plurality of cross members 5 that are suspended between the side members and extend in the vehicle width direction, and a floor panel 6 which forms a floor FL of the vehicle compartment 2 and is joined to the upper side of the cross member 5.

The cross members 5, the floor panel 6, and the like constituting the vehicle body 3 are made of steel unless otherwise specified. Further, each of the plurality of cross members 5 is formed with a hat-shaped cross section that opens upward.

Further, as shown in FIG. 1, a plurality of batteries 90 for supplying power to the electric motor or the like of the vehicle and a battery plate 91 for supporting the plurality of batteries 90 from below are provided below the floor panel 6. A sub-cross member 92 that extends in the vehicle width direction is provided on the upper surface of the battery plate 91 and the upper surface of the sub-cross member 92 is joined to the lower surface of the cross member 5 so that the battery plate 91 is attached below the floor panel 6.

As a vehicle seat 1, a front seat S1 serving as a driver seat or a passenger seat, a middle seat S2 provided in the second row, and a rear seat S3 provided in the third row are arranged on the floor FL from the front to the rear of the vehicle V.

Furthermore, when the front seat S1 is the first seat of the present invention, the middle seat S2 disposed behind the front seat S1 corresponds to the second seat of the present invention. Further, when the middle seat S2 is the first seat of the present invention, the rear seat S3 is the second seat of the present invention.

### <Vehicle Seat 1>

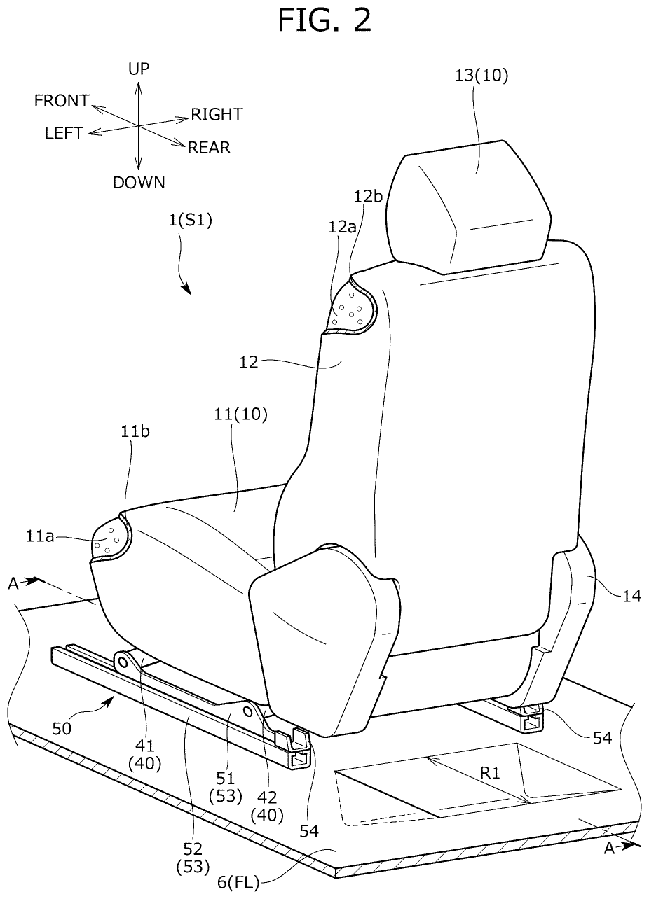

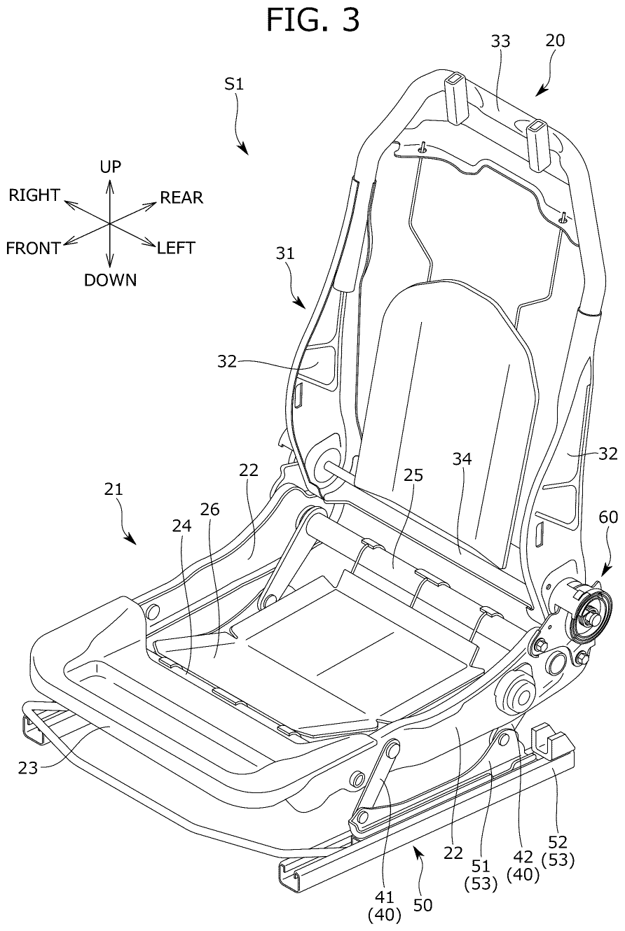

Hereinafter, the basic configuration of the vehicle seat 1 will be described with reference to FIGS. 2 and 3. FIG. 2 is a perspective view showing the vehicle seat 1 as viewed from the rear, and in the drawings, for convenience of illustration, a part of the vehicle seat 1 is shown with a cushion pad 11a, a back pad 12a, and cover materials 11b and 12b removed. FIG. 3 is a perspective view showing a seat frame 20 that forms the framework of the vehicle seat 1.

The vehicle seat 1 is a seat which is placed on the floor FL (more specifically, on the floor panel 6) in the vehicle compartment 2 and on which an occupant of the vehicle V sits. The vehicle seat 1 is used as the front seat S1 of the vehicle V. However, the present invention is not limited thereto, and the vehicle seat 1 can also be used as the middle seat S2 of the second row or the rear seat S3 of the third row located behind the front seat S1.

In this embodiment, the vehicle seat 1 mainly includes a seat body 10, a height adjustment mechanism 40, and a slide mechanism 50 and is attached into the vehicle compartment 2 of the vehicle V.

The seat body 10 is attached at a predetermined height from the floor FL of the vehicle compartment through the height adjustment mechanism 40 and the slide mechanism 50.

### <Seat Body 10>

As shown in FIG. 2, the seat body 10 mainly includes a seat cushion 11 which serves as a seating portion that supports the buttocks of the seated occupant, a seat back 12 which serves as a backrest that supports the back of the seated occupant, and a headrest 13 which is disposed at the upper part of the seat back 12 and supports the head of the seated occupant.

The seat cushion 11 is configured by covering a seat cushion frame 21 (see FIG. 3) with the cushion pad 11a (the pad member) and the cover material 11b. The seat back 12 is configured by covering a seat back frame 31 (see FIG. 3) with a back pad 12a (a pad member) and a cover material 12b. The headrest 13 is configured by covering a headrest frame with a pad and a cover material.

The cushion pad 11a and the back pad 12a are made of a urethane base material formed by foam molding using, for example, a urethane foam material, and the cover materials 11b and 12b are made of, for example, cloth, synthetic leather, genuine leather, or the like.

The seat cushion 11 and the seat back 12 are connected by a reclining mechanism 60 (see FIG. 3). The reclining mechanism 60 allows the seat back 12 to rotate relative to the seat cushion 11, and the inclination angle of the seat back 12 can be adjusted. Side covers 14 that cover the reclining mechanism 60 are provided on both sides of the seat body 10.

Further, a lower space US is formed between the seat cushion 11 and the floor FL below the seat body 10.

### <Seat Frame 20>

As shown in FIG. 3, the seat frame 20 is provided within the vehicle seat 1 as the framework thereof. The seat frame 20 includes the seat cushion frame 21 which forms the framework of the seat cushion 11 and the seat back frame 31 which forms the framework of the seat back 12.

### <Seat Cushion Frame 21>

The seat cushion frame 21 is formed in a rectangular frame shape, and a pair of cushion side frames 22 are provided on the right and left sides of the seat cushion frame 21. Further, the seat cushion frame 21 includes a front pipe 24 that connects the pair of cushion side frames 22 and 22 at the front side and a rear pipe 25 that connects them at the rear side. The front pipe 24 and the rear pipe 25 at the front and rear of the vehicle seat 1 are formed by round pipes. Further, a pan frame 23 is provided on the further front side of the front pipe 24.

Each of the cushion side frames 22 is disposed on the right and left sides of the seat cushion frame 21, and each of the cushion side frames 22 extends in the front to rear direction of the vehicle seat 1.

A front actuator and a rear actuator (not shown) that operate the movable portions (front link 41 and rear link 42 to be described later) of the height adjustment mechanism 40 are attached to the outer side surface of the left cushion side frame.

The seat cushion 11 is provided with a plate-shaped pressure receiving member 26 that receives a load from the buttocks of the seated occupant. As shown in FIG. 3, the pressure receiving member 26 is a plate-shaped member made of resin, and the cushion pad 11a is placed on the pressure receiving member 26.

The pressure receiving member 26 is provided across the front pipe 24 and the rear pipe 25 in the seat cushion frame 21. More specifically, wires are inserted into the pressure receiving member 26 at the right and left end portions and the center to extend in the front to rear direction, and the pressure receiving member is fixed to the front pipe 24 and the rear pipe 25 by hooks formed at the front and rear ends of the wires.

### <Seat Back Frame 31>

The seat back frame 31 is formed in a rectangular frame shape as a whole. The seat back frame 31 includes a pair of back side frames 32 and 32 which are arranged on the right and left, an upper frame 33, and a lower frame 34. The upper frame 33 is a connection member that is disposed between the pair of back side frames 32 and 32 and connects the upper ends of the pair of back side frames 32 and 32. The lower frame 34 is a connection member which is disposed between the pair of back side frames 32 and 32 and connects the lower ends of the pair of back side frames 32 and 32. The back side frame 32, the upper frame 33, and the lower frame 34 are formed by plate-shaped members.

### <Height Adjustment Mechanism 40>

The height adjustment mechanism 40 is disposed between the seat cushion frame 21 and an upper rail 51 constituting the slide mechanism 50 in the up to down direction. Then, when the occupant performs a height adjustment operation (for example, an operation of pressing a lift button (not shown)), the movable portion of the height adjustment mechanism 40 is operated by the front actuator and the rear actuator (not shown). Accordingly, the height of the vehicle seat 1 including the seat cushion 11 is adjusted.

The height adjustment mechanism 40 includes the front link 41 located at the front and the rear link 42 located at the rear. The front link 41 and the rear link 42 form a pair to adjust the height of the vehicle seat 1.

### <Slide Mechanism 50>

Further, as shown in FIGS. 2 and 3, the slide mechanism 50 is provided below the vehicle seat 1. By means of this slide mechanism 50, the seat body 10 of the vehicle seat 1 is attached to the floor FL (more specifically, the floor panel 6) to be slidable in the front to rear direction.

The slide mechanism 50 is a device for sliding the seat body 10 of the vehicle seat 1 along the front to rear direction and has a known structure (a structure of a general slide mechanism). The slide mechanism 50 includes a lower rail 52 fixed on the floor panel 6 and an upper rail 51 slidable relative to the lower rail 52 as a pair of slide rails 53. The upper rail 51 connected to the seat body 10 is slidable relative to the lower rail 52 fixed on the floor panel 6.

### <Concave Portion 70 of Floor FL>

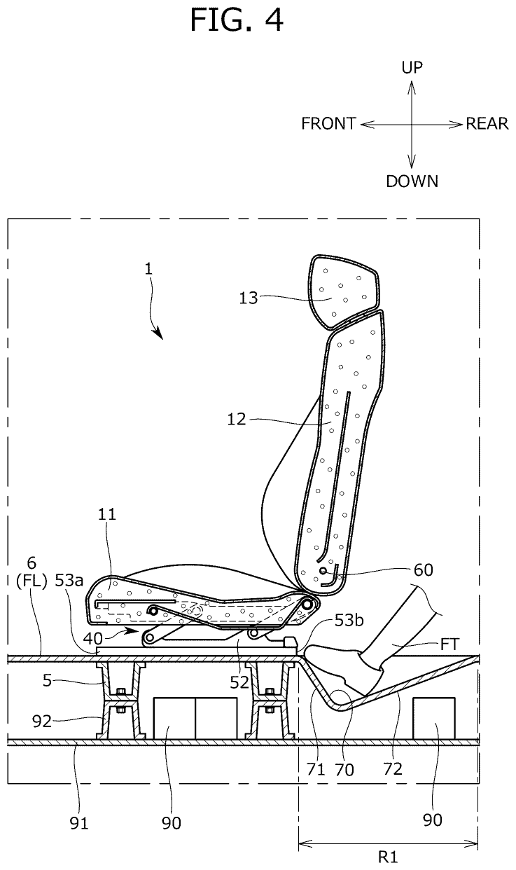

As shown in FIGS. 2 and 4, the vehicle V of this embodiment includes a footrest concave portion 70 formed in the floor FL and including at least a region R1 located behind the vehicle seat 1. More specifically, the vehicle V includes the concave portion 70 for placing the feet at a position behind the rear ends of the pair of slide rails 53 (more specifically, the lower rail 52) of the slide mechanism.

The concave portion 70 is formed by deforming the floor panel 6 and the concave portion 70 is formed so that the cross section is triangular as shown in FIG. 4A.

The concave portion 70 includes a front inclined surface 71 and a rear inclined surface 72 for placing the feet FT of the occupant sitting on the middle seat S2. In particular, the front inclined surface 71 is inclined at an angle that allows the occupant to easily place the feet when seated.

Furthermore, the cross-sectional shape of the concave portion 70 is not limited to a triangular shape, but may be a rectangular shape or a curved shape that protrudes downward.

As shown in FIG. 4, although it is a simple configuration, the foot entry is improved by expanding the space for placing the feet of the occupant sitting on the rear middle seat S2 downward in such a manner that the concave portion 70 is formed in the floor FL including the region R1 behind the vehicle seat 1.

Further, it is possible to expand a space for placing the feet of the seated occupant while ensuring a space for arranging the battery 90 and the like below the floor FL by forming the cross section of the concave portion 70 in a triangular shape.

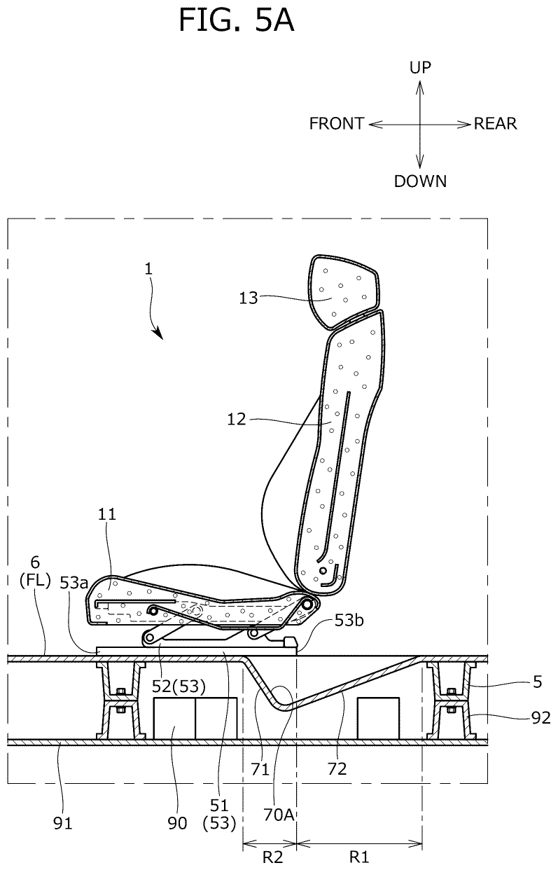

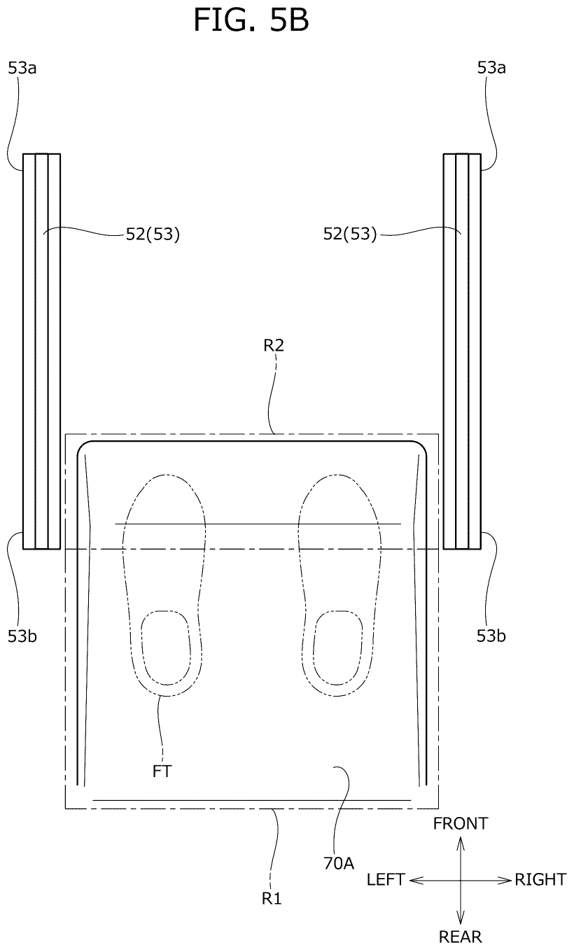

FIGS. 5A and 5B show a concave portion 70A which is another example of the concave portion 70. The concave portion 70A is also formed as a footrest concave portion including the region R1 located behind the vehicle seat 1. The concave portion 70A is further formed to extend into the lower space US below the seat cushion 11.

That is, the concave portion 70A is formed between the pair of slide rails 53 (more specifically, the lower rails 52) of the slide mechanism 50 to include a region R2 located in front of rear ends 53b of the pair of slide rails 53.

Similarly to the concave portion 70 shown in FIG. 4A, the concave portion 70A is formed by deforming the floor panel 6 so that the cross section is triangular. By forming the cross section of the concave portion 70A in a triangular shape, it is possible to expand a space for placing the feet of the seated occupant while ensuring a space for arranging the battery and the like below the floor FL.

Although the shape of the floor FL becomes complex, since the feet can also be entered below the seat cushion 11, the foot entry space of the occupant sitting on the rear seat is expanded not only downward but also forward, and hence the foot entry can be further improved.

Furthermore, the cross-sectional shape of the concave portion 70A is not limited to a triangular shape, but may be a rectangular shape or a curved shape that protrudes downward.

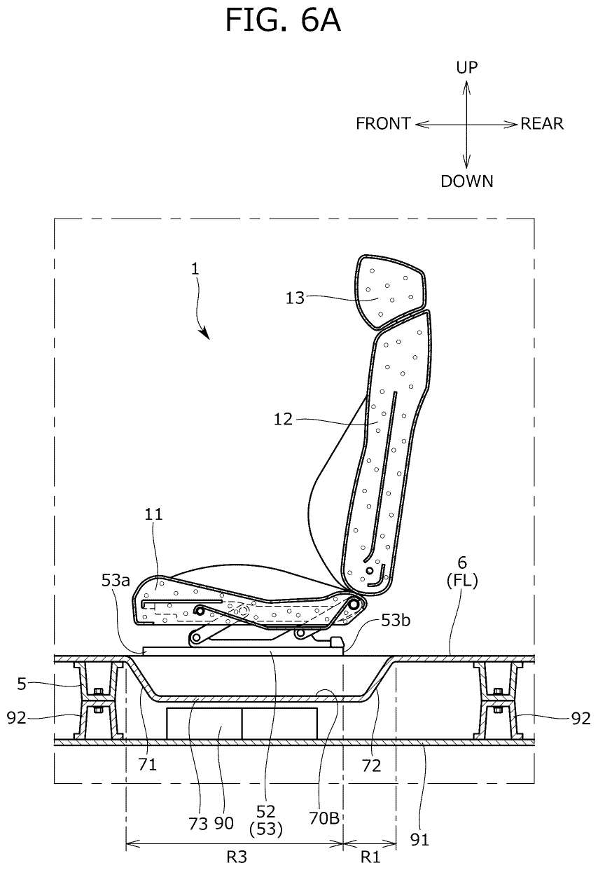

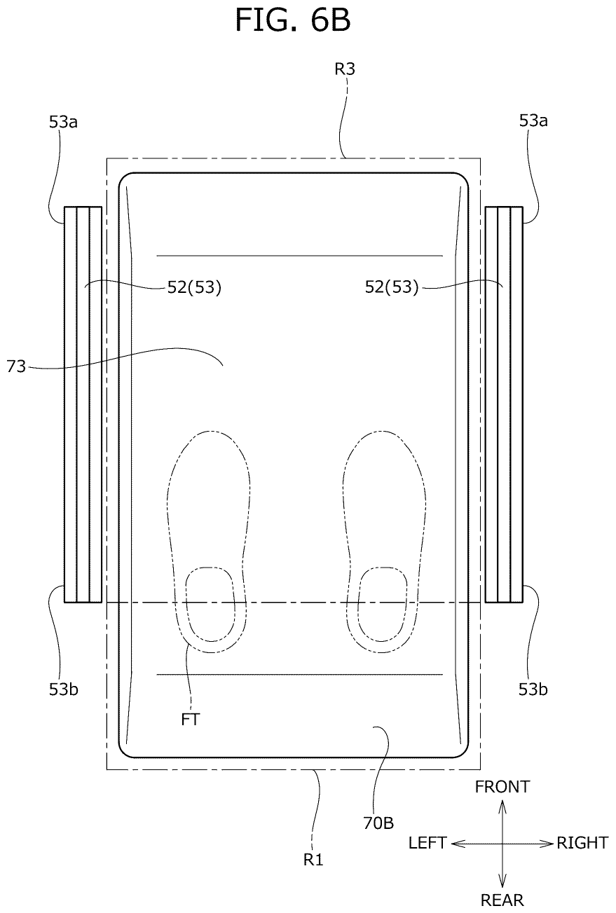

FIGS. 6A and 6B show a concave portion 70B which is still another example of the concave portion 70. The concave portion 70B is also formed as a footrest concave portion including the region R1 located behind the vehicle seat 1. Further, the concave portion 70B is formed to extend into the lower space US of the seat cushion 11 and is formed to include a region R3 continuously extending from the front to the rear of the pair of slide rails 53 of the slide mechanism 50.

As shown in FIG. 6A, the concave portion 70B has a rectangular cross section, more specifically, a trapezoidal cross section. The concave portion 70B is formed so that a bottom surface 73 is closer to the upper surface of the battery 90 disposed below the floor FL. Since the space for entering the feet FT of the occupant is expanded downward and forward, the foot entry can be further improved.

Furthermore, the cross-sectional shape of the concave portion 70B is not limited to a rectangular shape, and may be a downwardly protruding triangular shape or a curved shape.

Hereinafter, the positional relationship between the concave portion 70 formed in the floor FL and other members provided on the floor FL will be described.

As described above, in the vehicle V, the cross member 5 (beam member) that extends in the right to left direction below the floor FL as described above and supports the floor panel 6 is provided. The cross member 5 is disposed below the front end portion and the rear end portion of the slide rail 53 of the vehicle seat 1. Further, the cross member 5 is connected to the sub-cross member 92 of the battery plate 91 that supports the battery 90.

As shown in FIG. 4, the concave portion 70 is provided at a position avoiding the cross member 5 below the floor FL. In other words, the concave portion 70 can be formed in a region in which the cross member 5 is not disposed. It is possible to easily form the concave portion 70 without affecting the cross member 5 by providing the concave portion 70 at a position avoiding the cross member 5 below the floor FL.

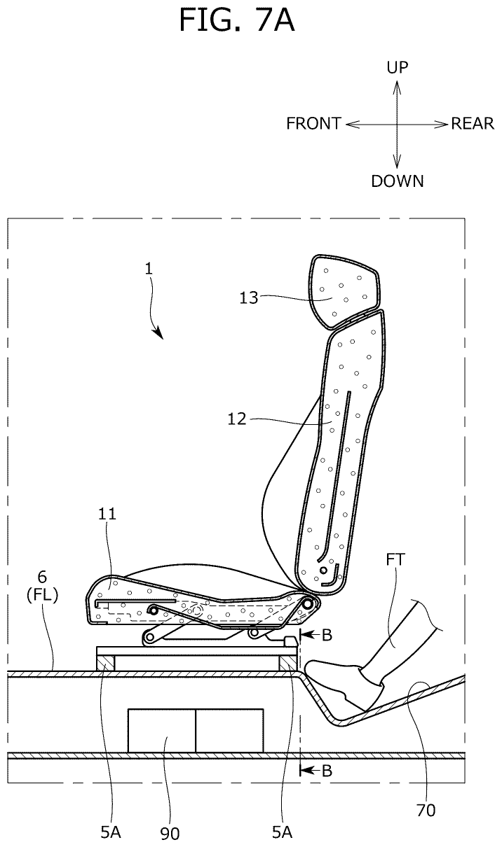

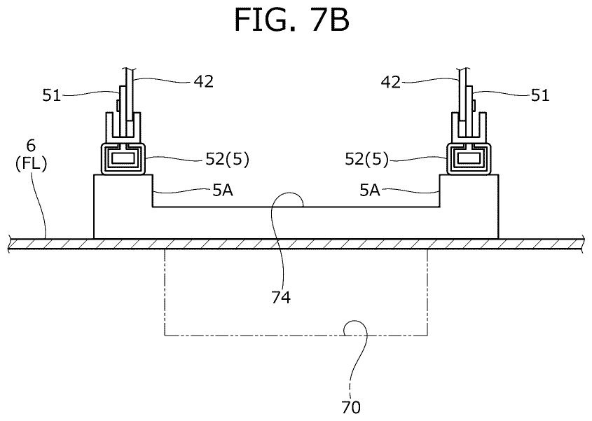

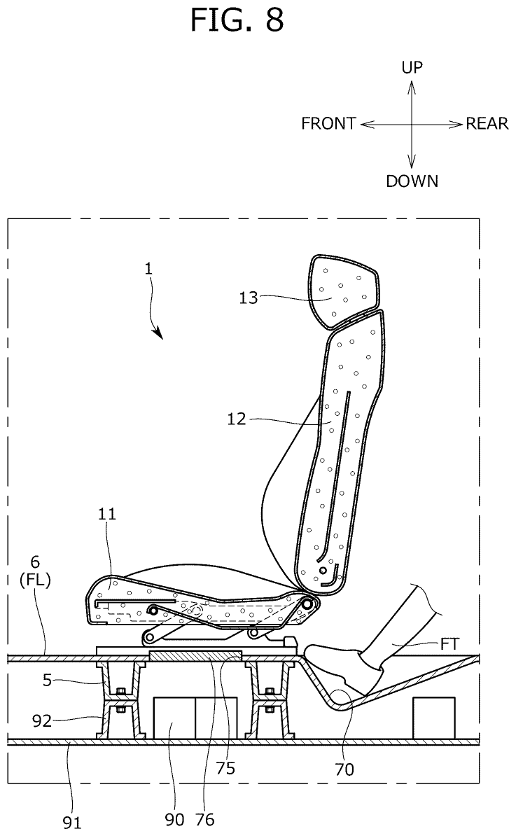

The cross member 5 of the vehicle V shown in FIG. 7 is provided below the floor FL, but as shown in FIG. 8A, the cross member 5A may be provided on the floor depending on the structure of the vehicle V. The cross member 5A also extends in the right to left direction of the vehicle V as the beam member and supports the floor panel 6. As shown in FIG. 8A, the cross member 5A is connected to a front end 53a and a rear end 53b of the slide rail 53 and supports the vehicle seat 1.

Furthermore, the cross member 5A may be formed by bending a part of the floor panel 6 into an inverted groove shape and forming a convex beam member extending to the right and left.

As shown in FIG. 8A, the concave portion 70 is provided at a position avoiding the cross member 5A on the floor FL. In other words, the concave portion 70 is formed in a region in which the cross member 5A is not disposed. That is, the concave portion 70 is formed at a position behind the cross member 5A located behind the vehicle seat 1. It is possible to easily form the concave portion 70 without affecting the cross member 5A by providing the concave portion 70 at a position avoiding the cross member 5A on the floor FL.

Furthermore, as shown in FIG. 8B, in the cross member 5A on the floor FL, a recess portion 74 may be formed between the pair of slide rails 53 of the vehicle seat 1 at the upper part of the cross member 5A. Since the recess portion 74 is formed, the occupant can enter the feet into the lower space US below the seat cushion 11 and hence the foot entry can be improved.

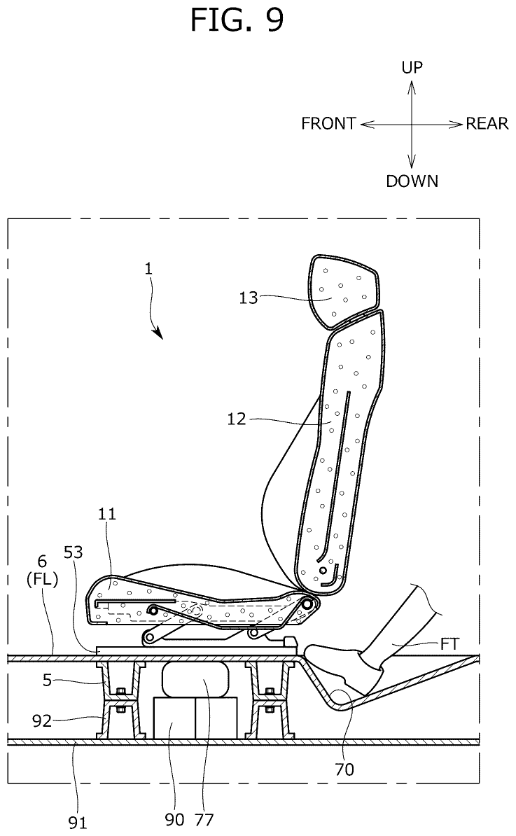

Further, as shown in FIG. 9, an opening portion 75 may be formed in the floor FL of the vehicle V to provide access to the battery 90 disposed below the floor FL. The opening portion 75 is often provided in a region R4 located below the vehicle seat 1 to be hidden from direct view by the occupant. When the opening portion 75 is formed, a lid portion 76 for closing the opening portion 75 is disposed on the floor FL.

As shown in FIG. 9, the concave portion 70 is formed at a position avoiding the lid portion 76 disposed on the floor FL. In other words, the concave portion 70 is formed in a region in which the opening portion 75 or the lid portion 76 is not formed. Since the concave portion 70 is formed at a position avoiding the lid portion 76 that closes the opening portion 75, the foot entry can be improved by forming the concave portion 70 without affecting the lid portion 76.

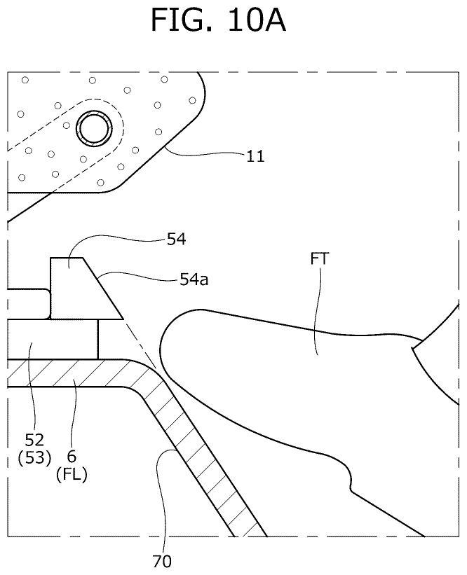

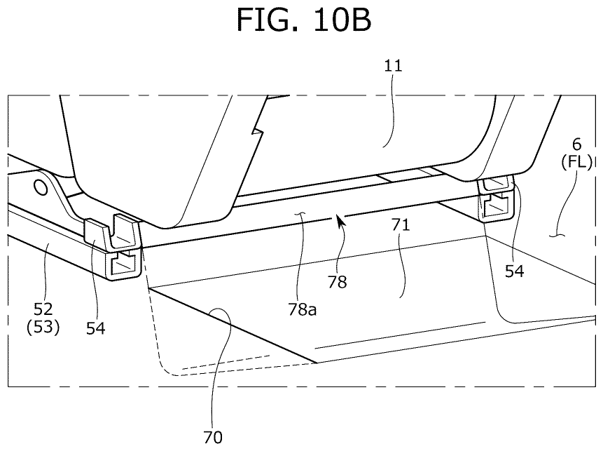

Further, as shown in FIG. 10, a shock absorbing member 77 may be disposed between the floor panel 6 and the battery 90 disposed below the floor FL of the vehicle V. The shock absorbing member 77 is a member for preventing a shock from the floor FL from being directly transmitted to the battery 90, and is made of, for example, rubber or a urethane foam material.

Instead of the shock absorbing member 77, a vibration isolating material made of an elastic material such as resin or rubber may be provided. By disposing a vibration isolating material between the battery 90 and the floor panel 6, it is possible to suppress vibration of the battery 90 and also to suppress noise transmitted from the floor panel 6 to the interior of the vehicle.

As shown in FIG. 10, the concave portion 70 is formed at a position avoiding a member such as the shock absorbing member 77 between the floor FL and the battery 90.

In other words, the concave portion 70 is formed in a region in which the shock absorbing member 77 and the like are not arranged. Since the concave portion 70 is formed at a position avoiding a member disposed between the floor FL and the battery 90, the foot entry can be improved by forming the concave portion 70 without affecting the member.

### <Footrest Portion 78>

A foot cover 54 is provided at the pair of slide rails 53 of the slide mechanism 50, more specifically, the rear portions of the pair of lower rails 52. By providing the foot cover 54, the feet FT of the occupant does not directly touch the slide rail 53.

When the concave portion 70 is formed in the floor FL behind the vehicle seat 1, the foot cover 54 may have an inclined surface 54a that is inclined downward as it goes toward the rear of the vehicle V as shown in FIG. 10A.

By providing the inclined surface 54a on the foot cover 54, the inclined surface 54a is integrated with the concave portion 70 formed at the rear thereof and hence the feet can be easily placed.

Furthermore, as shown in FIG. 10B, a footrest portion 78 having an inclined surface 78a may be formed by connecting the foot covers 54 of the slide rails 53 arranged on the right and left. In other words, the vehicle seat 1 includes the foot cover 54 that is integrally formed by spanning the rear end of the slide rail 53 as the footrest portion 78, and the foot cover 54 (footrest portion 78) may have the inclined surface 78a that is inclined downward as it goes toward the rear of the vehicle V.

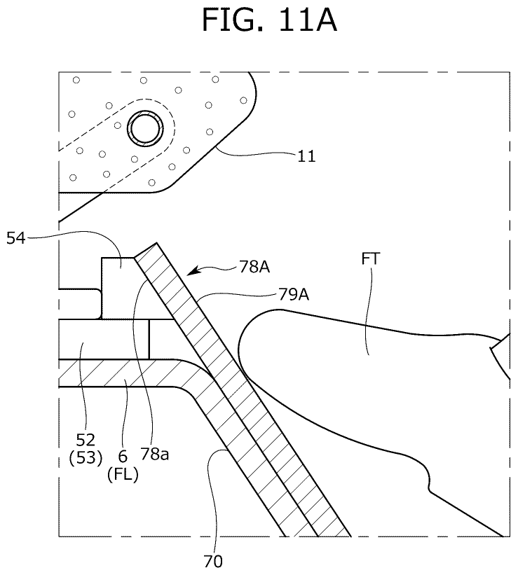

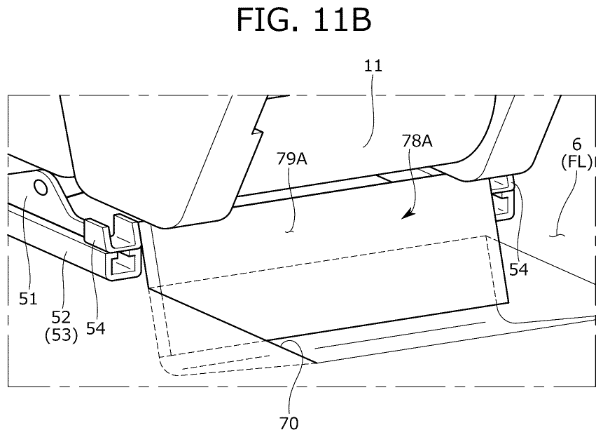

Further, as shown in FIGS. 11A and 11B, when a footrest portion 78A is formed by connecting the foot covers 54 arranged on the right and left, the inclined surface 78a may be formed to extend to the concave portion 70 formed in the floor FL. For example, a plate-shaped inclined plate 79A may be placed on the inclined surface 78a to be continuous to the front inclined surface 71 of the concave portion 70. By extending the inclined surface 78a to the concave portion 70, the foot can be more easily placed.

As described above, the vehicle V according to the first embodiment of the present invention has been described with reference to the drawings. Furthermore, the vehicle seat 1 mounted on the vehicle V includes the height adjustment mechanism 40, but the present invention can also be applied to the vehicle V equipped with the vehicle seat 1 without the height adjustment mechanism 40. Further, although the vehicle V has been described as a vehicle with three rows of seats in the front and rear, the present invention can also be applied to a vehicle with two rows of seats consisting of a front seat and a rear seat.

### Second Embodiment

Hereinafter, a conveyance seat according to a second embodiment of the present invention will be described with reference to the drawings.

### TECHNICAL FIELD

A second embodiment relates to a conveyance seat and particularly to a conveyance seat disposed on a conveyance floor.

### BACKGROUND ART

In an electric vehicle (EV vehicle), batteries are often placed below a vehicle floor to accommodate more batteries. Therefore, the floor is made higher than that of an engine vehicle to ensure a space for the batteries. However, the seat height needs to be lowered in order to maintain the driver's eye point without changing the position of a vehicle ceiling. Therefore, the space between a seat cushion and the floor needs to be narrower than in the engine vehicle.

On the other hand, an occupant sitting on a rear seat located behind a front seat may want to take a relaxed posture of stretching out the feet by entering the feet below the front seat. However, if the space between the seat cushion of the front seat and the floor is narrow, there is a possibility that the feet may come into contact with electrical components (harnesses and the like) located on the bottom surface of the seat cushion when the feet enter below the seat cushion.

Japanese Patent Application Laid-Open No. 2021-91346 discloses a technology for protecting electrical components installed below a seat cushion with a plate-shaped cover member to prevent feet of an occupant of a rear seat from touching the electrical components in an EV vehicle having a narrow space below the seat cushion.

### SUMMARY OF INVENTION

### Techinical Problem

However, even in the case of the protection using the cover member, there is a possibility that a strong impact is applied when kicked by the feet and hence there is a limit when reducing damages to electrical components.

The present invention has been made in view of the above-described problems and an object thereof is to provide a conveyance seat in which a foreign object is suppressed from entering below a seat cushion from behind the conveyance seat.

### Solution to Problem

According to the conveyance seat of the present invention, the above-described problems are solved by a conveyance seat disposed on a conveyance floor, including: a seat cushion on which an occupant sits; and an entry suppressing portion which is disposed between a region on a rear end side of the seat cushion and the floor and suppresses a foreign object from behind the conveyance seat from entering between the seat cushion and the floor.

Since the conveyance seat includes the entry suppressing portion provided between the region on the rear end side of the seat cushion and the floor, a foreign object, for example, an occupant's foot or luggage is suppressed from entering below the seat cushion. Accordingly, damage to the bottom surface of the seat cushion or electrical components arranged at the lower side can be reduced.

Further, in the conveyance seat, the seat cushion may include a pressure receiving member that receives a load from the occupant, and the entry suppressing portion may be formed by a protruding portion protruding from a back surface side of a rear end of the pressure receiving member toward the floor.

Since the entry suppressing portion is formed by the protruding portion protruding from the back surface side of the rear end of the pressure receiving member toward the floor, the entry suppressing portion can be realized with a simple configuration.

Further, in the conveyance seat, the protruding portion may be formed by protruding the rear end of the pressure receiving member toward the floor.

Since the entry suppressing portion is integrally formed so that the rear end of the pressure receiving member protrudes, the entry suppressing portion can be realized without increasing the number of components.

Further, in the conveyance seat, the protruding portion may be provided to avoid the harness engagement portion that engages with the harness member arranged on the pressure receiving member.

Since the entry suppressing portion is provided such that the protruding portion avoids the harness engagement portion, the entry suppressing portion can be provided without affecting, for example, the harness member or the harness engagement portion.

Further, in the conveyance seat, the seat cushion may include a pad and a cushion side cover covering the pad and the entry suppressing portion may be formed by a bag-shaped portion formed in the rear portion of the cushion side cover.

Since the entry suppressing portion is formed at the rear portion of the cushion side cover, the entry suppressing portion can be realized without increasing, for example, the number of components.

Further, the conveyance seat may further include a seat back which is connected to a rear portion of the seat cushion to provide a backrest for the occupant; and a back pocket which is provided on a rear surface of the seat back, the back pocket may have a surface portion that is rotatable about a lower end, and the entry suppressing portion may be formed by the surface portion of the back pocket which rotates and has an upper end portion connected to the floor.

Since the entry suppressing portion is formed by rotating the surface portion of the back pocket provided on the rear surface of the seat back, the entry suppressing portion can be provided if necessary. Further, the entry suppressing portion can be realized by using the back pocket without increasing the number of components.

Further, the conveyance seat may further include a seat back which is connected to the rear portion of the seat cushion to provide a backrest for the occupant, the seat back may include a pad and a back cover covering the pad, and the entry suppressing portion may be formed by a hanging portion that hangs down from the lower end of the back cover.

Since the entry suppressing portion is formed by a hanging portion that hangs down from the lower end of the seat back, the entry suppressing portion can be realized without increasing, for example, the number of components.

Further, in the conveyance seat, the entry suppressing portion may be formed by the protrusion protruding from the floor.

Since the entry suppressing portion is formed by the protrusion protruding from the floor, the entry suppressing portion can be realized with a simple configuration.

Further, in the conveyance seat, the seat cushion may include side covers on the right and left sides and the entry suppressing portion may be formed by a plate-shaped member that connects the rear end portions of the right and left side covers and extend toward the floor.

Since the entry suppressing portion is formed by the plate-shaped member connecting the rear end portion of the side cover, the entry suppressing portion can be realized with a simple configuration.

### Advantageous Effects of Invention

According to the present invention, since the conveyance seat includes the entry suppressing portion provided between the region on the rear end side of the seat cushion and the floor, a foreign object, for example, an occupant's foot or luggage is suppressed from entering below the seat cushion. Accordingly, damage to the bottom surface of the seat cushion or electrical components arranged at the lower side can be reduced.

Further, according to the present invention, since the entry suppressing portion is formed by the protruding portion protruding from the back surface side of the rear end of the pressure receiving member toward the floor, the entry suppressing portion can be realized with a simple configuration.

Further, according to the present invention, since the entry suppressing portion is formed by protruding the rear end of the pressure receiving member, the entry suppressing portion can be realized without increasing the number of components.

Further, according to the present invention, since the entry suppressing portion is integrally formed so that the rear end of the pressure receiving member protrudes, the entry suppressing portion can be realized without increasing the number of components.

Further, according to the present invention, since the entry suppressing portion is provided such that the protruding portion is provided to avoid the harness engagement portion, the entry suppressing portion can be provided without affecting, for example, the harness member or the harness engagement portion.

Further, according to the present invention, since the entry suppressing portion is formed at the rear portion of the cushion side cover, the entry suppressing portion can be realized without increasing, for example, the number of components.

Further, according to the present invention, since the entry suppressing portion is formed by rotating the surface portion of the back pocket provided on the rear surface of the seat back, the entry suppressing portion can be provided if necessary. Further, the entry suppressing portion can be realized by using the back pocket without increasing the number of components.

Further, according to the present invention, since the entry suppressing portion is formed by a hanging portion that hangs down from the lower end of the seat back, the entry suppressing portion can be realized without increasing, for example, the number of components.

Further, according to the present invention, since the entry suppressing portion is formed by the protrusion protruding from the floor, the entry suppressing portion can be realized with a simple configuration.

Since the entry suppressing portion is formed by the plate-shaped member connected to the rear end portion of the side cover, the entry suppressing portion can be realized with a simple configuration.

### DESCRIPTION OF EMBODIMENTS

Hereinafter, the configuration of a conveyance seat according to a second embodiment of the present invention will be described with reference to the drawings. However, the embodiment described below is intended to facilitate understanding of the present invention and is not intended to limit the present invention. That is, the present invention can be modified or improved without departing from the spirit of the invention, and it goes without saying that the present invention includes equivalents thereof.

Further, in the following description, the contents regarding the materials, shapes and sizes of the seat components are merely examples and do not limit the present invention.

Furthermore, in the following description, the vehicle seat mounted on the vehicle will be given as an example of the conveyance seat, and a configuration example thereof will be described.

### <Basic Configuration of Vehicle VA>

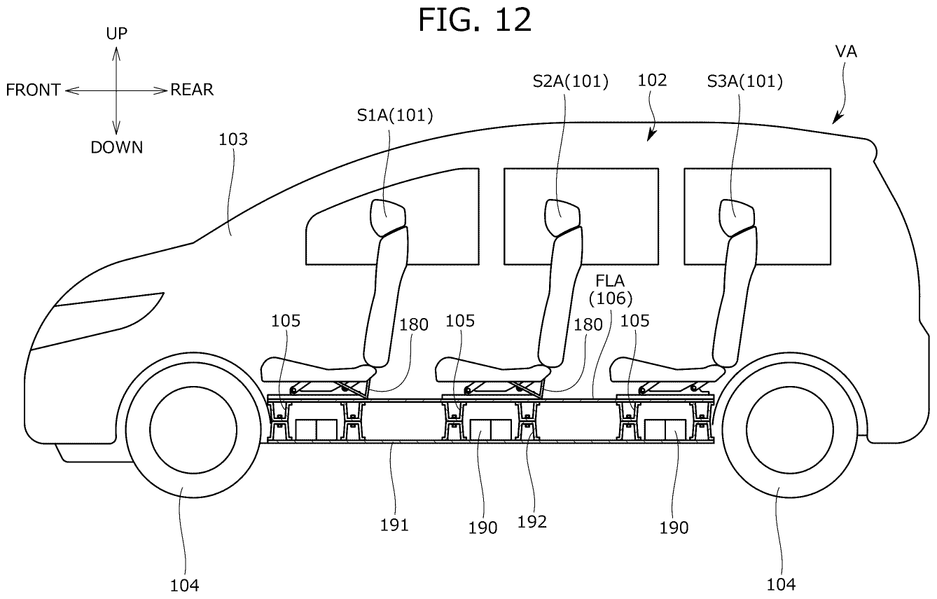

An example of a vehicle VA equipped with a vehicle seat 101 is shown in FIG. 12. The vehicle VA is a four-wheeled electric vehicle (EV) having four wheels. As shown in FIG. 12, the vehicle VA has a vehicle structure including a vehicle body 103 that defines a vehicle compartment 102 and four wheels 104 which are a pair of front wheels and a pair of rear wheels on the right and left.

The vehicle body 103 includes a pair of right and left side members (not shown) that extend in the front to rear direction of the vehicle, a plurality of cross members 105 that are suspended between the side members and extend in the vehicle width direction, and a floor panel 106 which forms a floor FLA of the vehicle compartment 102 and is joined to the upper side of the cross member 105.

The cross member 105, the floor panel 106, and the like constituting the vehicle body 103 are made of steel unless otherwise specified. Further, each of the plurality of cross members 105 is formed with a hat-shaped cross section that opens upward.

Further, as shown in FIG. 12, a plurality of batteries 190 for supplying power to the electric motor or the like of the vehicle and a battery plate 191 for supporting the plurality of batteries 190 from below are provided below the floor panel 106. A sub-cross member 192 that extends in the vehicle width direction is provided on the upper surface of the battery plate 191 and the upper surface of the sub-cross member 192 is joined to the lower surface of the cross member 105 so that the battery plate 191 is attached below the floor panel 106.

As a vehicle seat 101, a front seat S1A serving as a driver seat or a passenger seat, a middle seat S2A provided in the second row, and a rear seat S3A provided in the third row are arranged on the floor FLA from the front to the rear of the vehicle VA.

Furthermore, the vehicle on which the vehicle seat 101 is mounted is not limited to an electric vehicle, but may be an engine vehicle, a hybrid vehicle equipped with both a motor and an engine for driving, a vehicle equipped with a battery and a fuel cell as a power source, and the like.

### <Vehicle Seat 101>

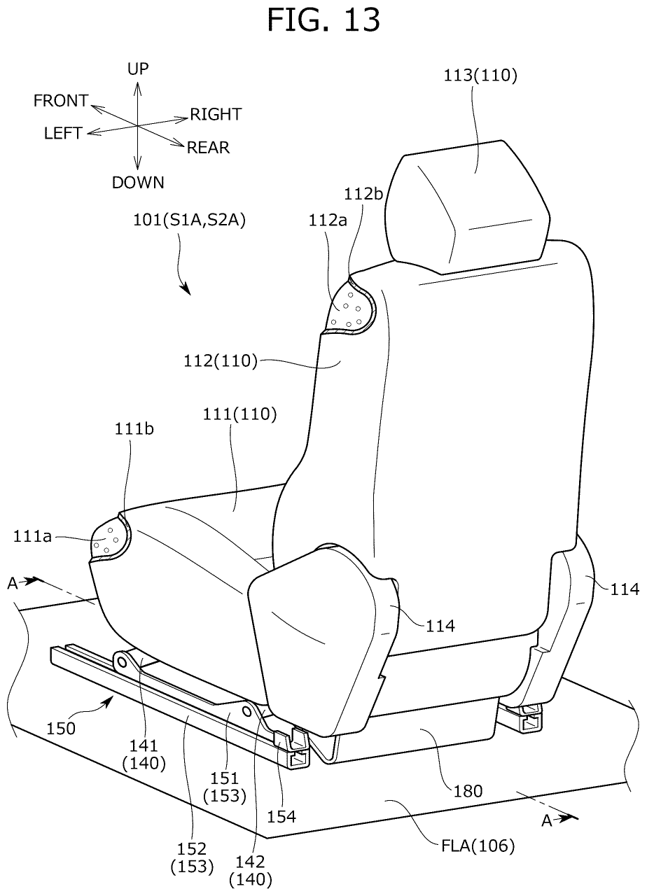

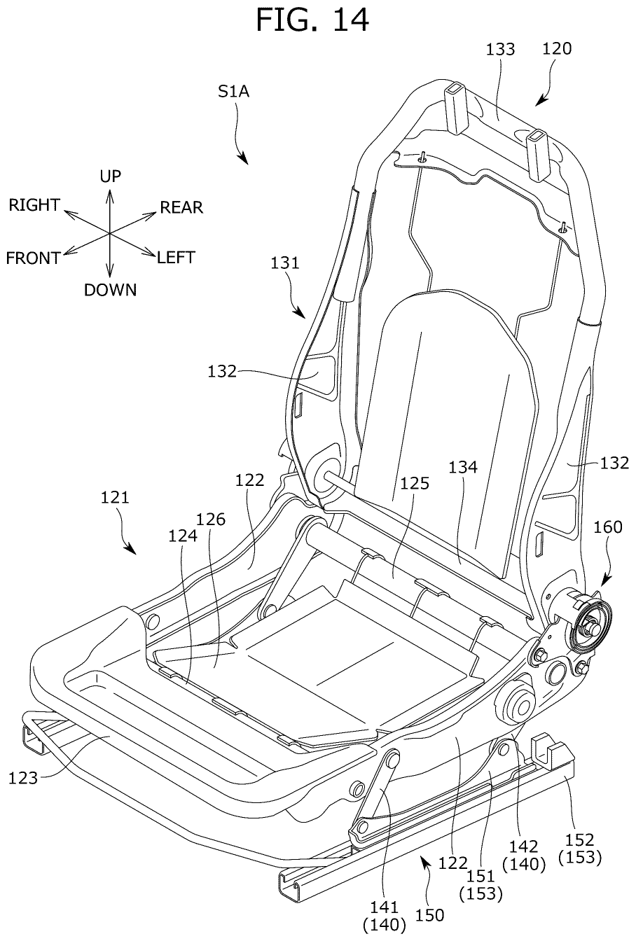

Hereinafter, the basic configuration of the vehicle seat 101 will be described with reference to FIGS. 13 and 14. FIG. 13 is a perspective view showing the vehicle seat 101 as viewed from the rear, and in the drawings, for convenience of illustration, a part of the vehicle seat 101 is shown with a cushion pad 111a, a back pad 112a, and cover materials 111b and 112b removed. FIG. 14 is a perspective view showing a seat frame 120 that forms the framework of the vehicle seat 101.

The vehicle seat 101 is a seat which is placed on the floor FLA (more specifically, on the floor panel 106) in the vehicle compartment 102 and on which an occupant of the vehicle VA sits. The vehicle seat 101 is used as the front seat S1A of the vehicle VA. However, the present invention is not limited thereto, and the vehicle seat 101 can also be used as the middle seat S2A of the second row or the rear seat S3A of the third row located behind the front seat S1A.

In this embodiment, the vehicle seat 101 mainly includes a seat body 110, a height adjustment mechanism 140, and a slide mechanism 150 and is attached into the vehicle compartment 102 of the vehicle VA.

The seat body 110 is attached at a predetermined height from the floor FLA of the vehicle compartment through the height adjustment mechanism 140 and the slide mechanism 150.

### <Seat Body 110>

As shown in FIG. 14, the seat body 110 mainly includes a seat cushion 111 which serves as a seating portion that supports the buttocks of the seated occupant, a seat back 112 which serves as a backrest that supports the back of the seated occupant, and a headrest 113 which is disposed at the upper part of the seat back 112 and supports the head of the seated occupant.

The seat cushion 111 is configured by covering a seat cushion frame 121 (see FIG. 14) with a cushion pad 111a (pad member) and a cover material 111b. The seat back 112 is configured by covering a seat back frame 131 (see FIG. 14) with a back pad 112a (pad member) and a cover material 112b. The headrest 113 is configured by covering a headrest frame with a pad and a cover material.

The cushion pad 111a and the back pad 112a are made of a urethane base material formed by foam molding using, for example, a urethane foam material, and the cover materials 111b and 112b are made of, for example, cloth, synthetic leather, genuine leather, or the like.

The seat cushion 111 and the seat back 112 are connected by a reclining mechanism 160 (see FIG. 14). The reclining mechanism 160 allows the seat back 112 to rotate relative to the seat cushion 111, and the inclination angle thereof can be adjusted. Side covers 114 that cover the reclining mechanism 160 are provided on both sides of the seat body.

Further, a lower space USA is formed between the seat cushion 111 and the floor FLA below the seat body 110.

### <Seat Frame 120>

As shown in FIG. 14, the seat frame 120 is provided within the vehicle seat 101 as the framework thereof. The seat frame 120 includes the seat cushion frame 121 which forms the framework of the seat cushion 111 and the seat back frame 131 which forms the framework of the seat back 112.

### <Seat Cushion Frame 121>

The seat cushion frame 121 is formed in a rectangular frame shape, and a pair of cushion side frames 122 are provided on the right and left sides thereof. Further, the seat cushion frame 121 includes a front pipe 124 that connects the pair of cushion side frames 122 and 122 at the front side and a rear pipe 125 that connects them at the rear side. The front pipe 124 and the rear pipe 125 at the front and rear of the vehicle seat 101 are formed by round pipes. Further, a pan frame 123 is provided on the further front side of the front pipe 124.

Each of the cushion side frames 122 is disposed on the right and left sides of the seat cushion frame 121, and each of the cushion side frames 122 extends in the front to rear direction of the vehicle seat 101.

A front actuator 143 and a rear actuator 144 that operate the movable portions (front link 141 and rear link 142 to be described later) of the height adjustment mechanism 140 are attached to the outer side surface of the left cushion side frame 122.

The seat cushion 111 is provided with a plate-shaped pressure receiving member 126 that receives a load from the buttocks of the seated occupant. As shown in FIG. 13, the pressure receiving member 126 is a plate-shaped member made of resin, and the cushion pad 111a is placed on the pressure receiving member 126.

The pressure receiving member 126 is provided across the front pipe 124 and the rear pipe 125 in the seat cushion frame 121. More specifically, wires are inserted into the pressure receiving member 126 at the right and left end portions and the center to extend in the front to rear direction, and the pressure receiving member is fixed to the front pipe 124 and the rear pipe 125 by hooks formed at the front and rear ends of the wires.

### <Seat Back Frame 131>

The seat back frame 131 is formed in a rectangular frame shape as a whole. The seat back frame 131 includes a pair of back side frames 132 and 132 which are arranged on the right and left, an upper frame 133, and a lower frame 134. The upper frame 133 is a connection member that is disposed between the pair of back side frames 132 and 132 and connects the upper ends of the pair of back side frames 132 and 132. The lower frame 134 is a connection member that is disposed between the pair of back side frames 132 and 132 and connects the lower ends of the pair of back side frames 132 and 132. The back side frame 132, the upper frame 133, and the lower frame 134 are formed by plate-shaped members.

### <Height Adjustment Mechanism 140>

The height adjustment mechanism 140 is disposed between the seat cushion frame 121 and an upper rail 151 constituting the slide mechanism 150 in the up to down direction. Then, when the occupant performs a height adjustment operation (for example, an operation of pressing a lift button (not shown)), the movable portion of the height adjustment mechanism 140 is operated by the front actuator and the rear actuator (not shown). Accordingly, the height of the vehicle seat 101 including the seat cushion 111 is adjusted.

The height adjustment mechanism 140 includes the front link 141 located at the front and the rear link 142 located at the rear. The front link 141 and the rear link 142 form a pair to adjust the height of the vehicle seat 101.

### <Slide Mechanism 150>

Further, as shown in FIGS. 13 and 14, the slide mechanism 150 is provided below the vehicle seat 101. By means of this slide mechanism 150, the seat body 110 of the vehicle seat 101 is attached to the floor FLA (more specifically, the floor panel 106) to be slidable in the front to rear direction.

The slide mechanism 150 is a device for sliding the seat body 110 of the vehicle seat 101 along the front to rear direction and has a known structure (a structure of a general slide mechanism). The slide mechanism 150 includes a lower rail 152 fixed on the floor panel 106 and an upper rail 151 slidable relative to the lower rail 152 as a pair of slide rails 153. The upper rail 151 connected to the seat body 110 is slidable relative to the lower rail 152 fixed on the floor panel 106.

### <Entry Suppressing Portion 180>

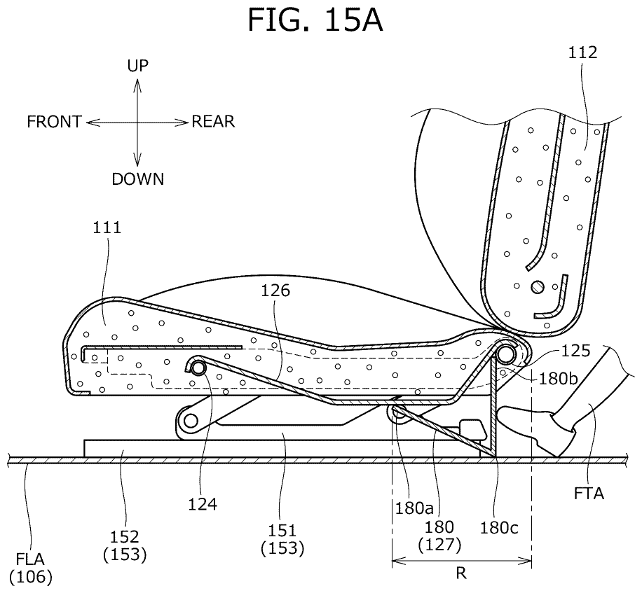

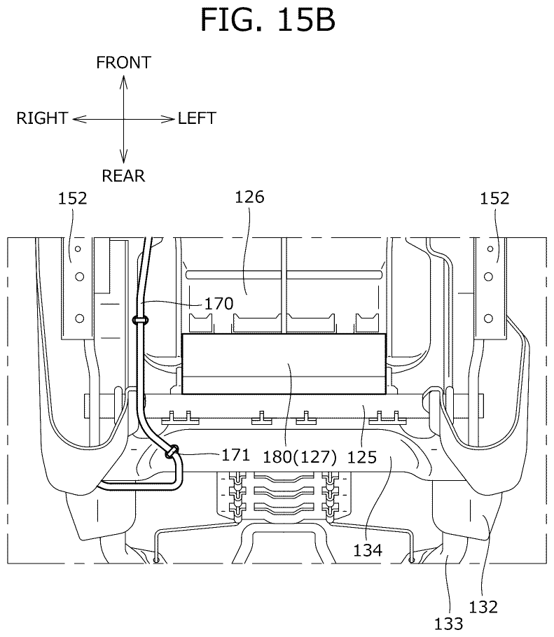

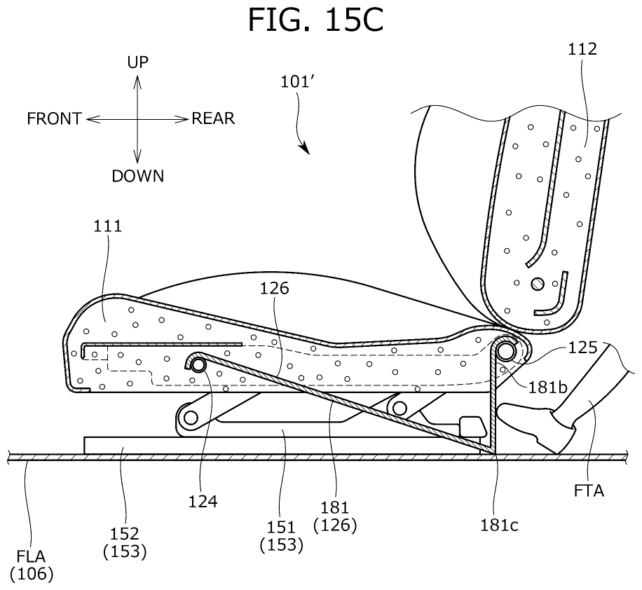

Hereinafter, the configuration of an entry suppressing portion 180 provided in the vehicle seat 101 of this embodiment will be described with reference to FIGS. 15A to 15C. The entry suppressing portion 180 is a member that is disposed between the region R on the rear end side of the seat cushion 111 and the floor FLA and suppresses a foreign object from behind the vehicle seat 101 between the seat cushion 111 and the floor FLA from entering below the seat cushion. As shown in FIG. 15A, the foreign object is feet FTA of the occupant sitting on, for example, the middle seat S2A or the rear seat S3A. The foreign object may include luggage such as a bag placed at the feet.

The entry suppressing portion 180 is configured by a protruding portion 127 that protrudes from the back surface side of the rear end of the pressure receiving member 126 (also called a resin mat) toward the floor FLA.

More specifically, the protruding portion 127 of the entry suppressing portion 180 is formed by a plate-shaped member of which the center portion is bent at an acute angle. As shown in FIG. 15A, a front end portion 180a of the entry suppressing portion 180 is locked in the vicinity of the center of the pressure receiving member 126 in the front to rear direction and a rear end portion 180b of the protruding portion 127 is locked to the connection portion between the rear pipe 125 and the pressure receiving member 126. The protruding portion 127 protrudes from the back surface side of the rear end of the pressure receiving member 126 toward the floor FLA. In other words, a bent portion 180c of the entry suppressing portion 180 extends downward from the rear end portion 180b and protrudes to approach the floor FLA.

In this way, the entry of the foreign object is suppressed by disposing the entry suppressing portion 180 to form a wall between the seat cushion 111 and the floor FLA. It is desirable that the bent portion 180c of the entry suppressing portion 180 comes into contact with the floor FLA. Further, the protruding portion 127 which is the entry suppressing portion 180 may be made of metal or resin.

The protruding portion 127 of the entry suppressing portion 180 shown in FIGS. 15A and 15B is formed by a separate member from the pressure receiving member 126, but as in a vehicle seat 101′ shown in FIG. 15C, the pressure receiving member 126 itself may protrude toward the floor FLA as an entry suppressing portion 181. That is, the rear end portion of the pressure receiving member 126 protrudes toward the floor FLA and a bent portion 181c is disposed to extend toward the floor FLA. It is desirable that the bent portion 181c which extends downward from the rear end portion of the pressure receiving member 126 comes into contact with the floor FLA. Since the pressure receiving member 126 is formed as the entry suppressing portion 181, the entry of the foreign object or the like can be suppressed without increasing the number of components.

Furthermore, as shown in FIG. 15B, a harness member 170 for transmitting power and signals to an electrical component provided in the vehicle seat 101 may be disposed on either the right or left side of the pressure receiving member 126. In FIG. 15B, the harness member 170 is secured to the lower frame 134 by a harness clip 171 (harness engagement portion).

The electrical components are, for example, the slide mechanism 150 and the height adjustment mechanism 140. Other examples of electrical components include control devices such as in-vehicle ECUs (Electronic Control Units, hereinafter simply referred to as “ECUs”) and display devices.

The entry suppressing portion 180 may be provided to avoid the harness member 170 or the harness clip 171 of the harness member 170. That is, the entry suppressing portion 180 may be disposed at a position different from the arrangement location of the harness member 170 or the harness clip 171.

The entry suppressing portions 180 and 181 can be provided at a position avoiding the harness member 170 or the harness clip 171 without affecting the harness member 170 or the harness clip 171 thereof.

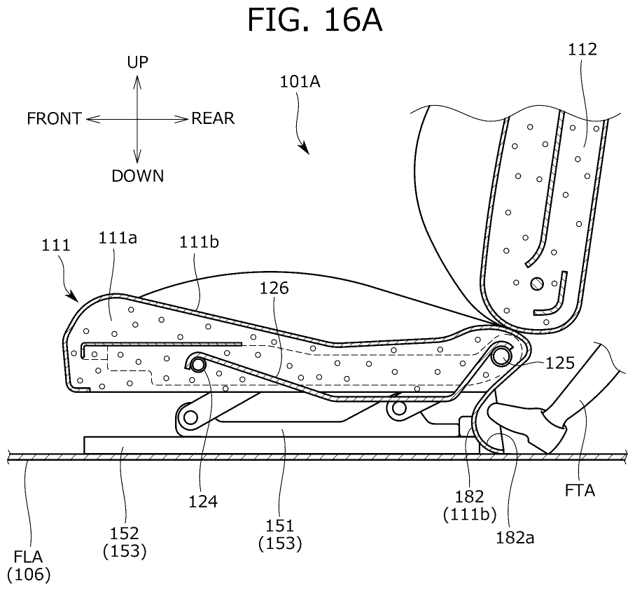

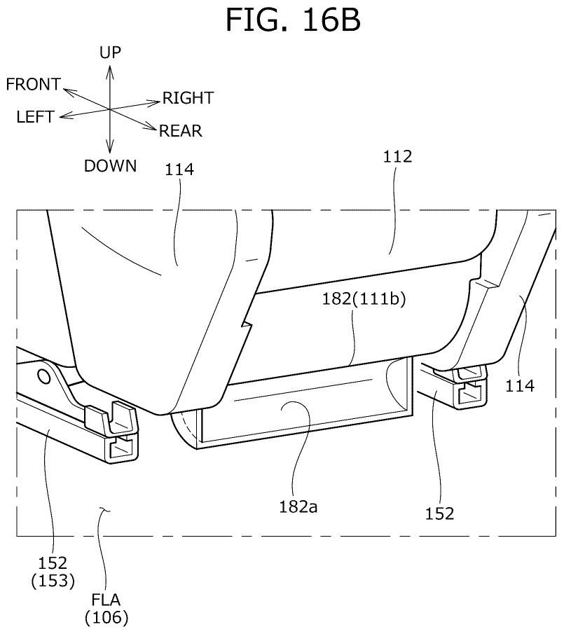

Next, an entry suppressing portion 182 which is another example of the entry suppressing portion 180 will be described with reference to FIGS. 16A and 16B. The entry suppressing portion 182 of a vehicle seat 101A shown in FIG. 16A is formed by the cover material 111b (the seat cushion side surface) that covers the cushion pad 111a (pad) of the seat cushion 111.

More specifically, in the entry suppressing portion 182, the cover material 111b is extended from the rear end portion of the seat cushion 111, the tip thereof is brought into contact with the floor FLA to form a wall between the seat cushion 111 and the floor FLA and to thereby suppress the entry of the foreign object. The rear end portion (bag-shaped portion 182a) of the cover material 111b has a C-shaped cross section and has walls at both ends to form a bag as shown in FIG. 16B. By forming the bag-shaped portion 182a at the rear end portion of the cover material 111b, it is possible to suppress the entry of the foreign object even when the cover material is made of cloth or leather.

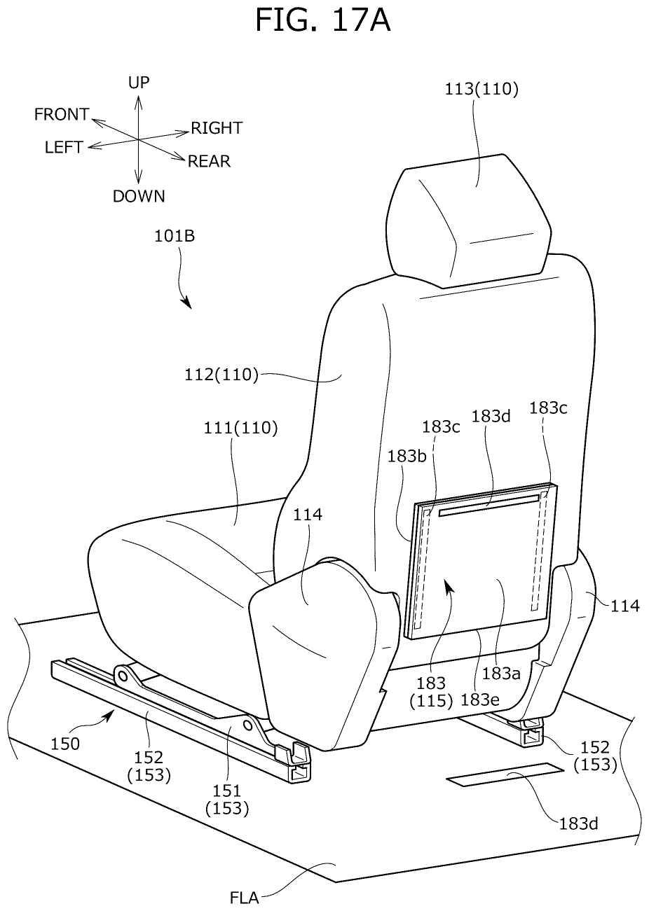

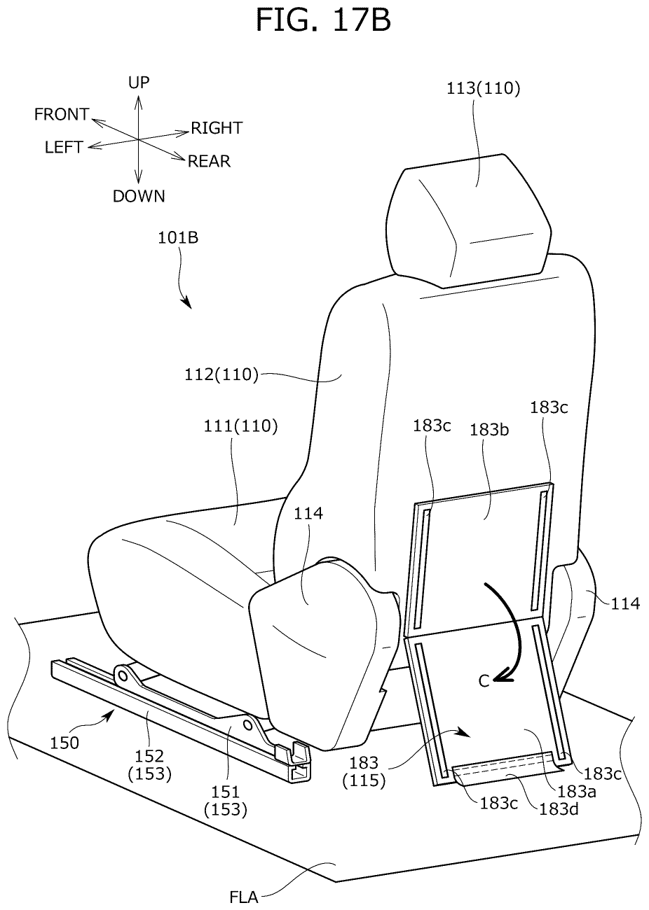

An entry suppressing portion 183 which is still another example of the entry suppressing portion 180 will be described with reference to FIGS. 17A and 17B. The entry suppressing portion 183 of a vehicle seat 101B shown in FIG. 17A realizes the entry suppressing portion 183 by using a back pocket 115 provided on the rear surface of the seat back 112.

The back pocket 115 is a bag-shaped member provided in the front seat for storing luggage of the occupant sitting on the rear seat of the vehicle seat 101, such as the middle seat S2A or the rear seat S3A.

The back pocket 115 includes a top surface member 183a that has a flat plate-shaped and a back surface member 183b that is connected to the top surface member 183a at a lower end 183e. The back surface member 183b is attached to the cover material 112b on the rear surface of the seat back 112 by, for example, sewing.

The top surface member 183a is attached to the back surface member 183b on both right and left sides by using a detachable attachment members 183c such as hook-and-loop fasteners. A occupant sitting on the rear seat can remove the top surface member 183a from the back surface member 183b, rotate the top surface member 183a in the direction of the arrow C in FIG. 17B about the lower end 183e as an axis, and hang down the upper end portion to the floor FLA. The upper end of the hanging top surface member 183a and the floor FLA may be fixed by using the detachable attachment members 183d such as hook-and-loop fasteners.

By hanging down the top surface member 183a to form a wall between the region on the rear end side of the seat cushion 111 and the floor FLA, the entry of the foreign object such as the feet FTA can be suppressed.

Furthermore, the attachment members 183c and 183d are not limited to the hook-and-loop fasteners, but may be wire fasteners, snap buttons, or the like.

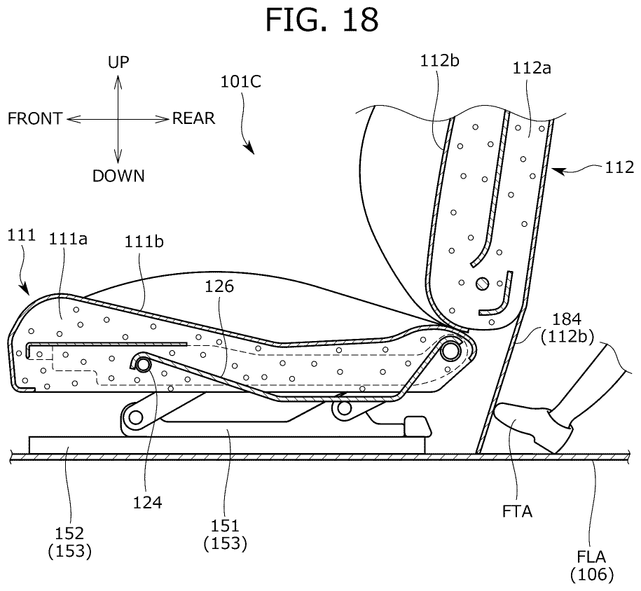

Furthermore, as in a vehicle seat 101C shown in FIG. 18, an entry suppressing portion 184 may be formed by a hanging portion of the cover material 112b (seat back cover) that is wrapped around the front of the seat back 112 below the seat back 112. In the entry suppressing portion 184, the hanging portion of the cover material 112b extends to the vicinity of the floor FLA. In this case, the lower end of the cover material 112b (hanging portion) may be removably fixed to the floor FLA using the attachment members such as the hook-and-loop fasteners.

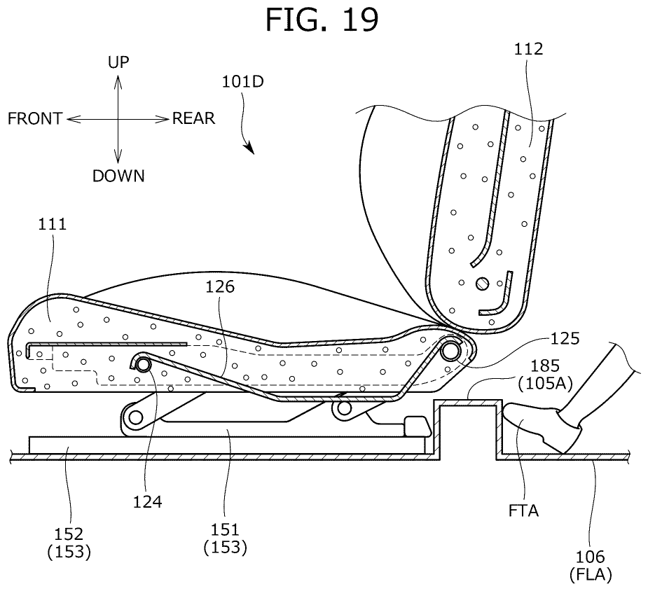

Further, as in a vehicle seat 101D shown in FIG. 19, an entry suppressing portion 185 may be formed by a protrusion that protrudes upward from the floor FLA. The protrusion is, for example, a cross member 105A that supports the floor FLA. A member for forming the protrusion may be provided separately from the cross member 105A. By disposing the vehicle seat 101 in front of the cross member 105A to form a wall between the seat cushion 111 and the floor FLA, the entry of the foreign object such as the feet FTA is suppressed.

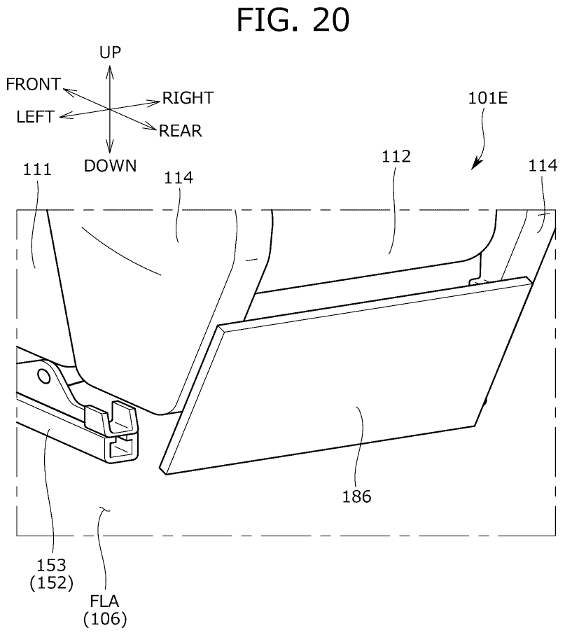

Further, as in a vehicle seat 101E shown in FIG. 20, an entry suppressing portion 186 may be realized by a plate-shaped member 116 that connects the rear end portions of the right and left side covers 114 at the rear of the vehicle seat 101 and extends downward.

The plate-shaped member 116 may be removably fixed to the side covers 114 on both sides using the detachable attachment members such as hook-and-loop fasteners. The plate-shaped member 116 may be made of resin or metal. Further, the plate-shaped member 116 of the entry suppressing portion 186 may be integrally formed with the side cover 114.

By providing the plate-shaped member 116 that connects the side covers 114 and extends to the floor FLA to form a wall between the seat cushion 111 and the floor FLA, the foreign object such as the feet of the occupant is suppressed from entering below the seat cushion 111.

As described above, the vehicle seat according to the second embodiment of the present invention has been described with reference to the drawings. Furthermore, the present invention is not limited to vehicle seats mounted on ground-traveling conveyances with wheels, such as automobiles and trains, but can also be applied to seats mounted on aircraft, ships, and other conveyances that move other than on land.

### Third Embodiment

Hereinafter, a conveyance seat according to a third embodiment of the present invention will be described with reference to the drawings.

### TECHNICAL FIELD

A second embodiment relates to a conveyance seat and particularly to a conveyance seat disposed on a conveyance floor.

### BACKGROUND ART

In an electric vehicle (EV vehicle), batteries are often placed below a vehicle floor to accommodate more batteries. Therefore, the floor is made higher than that of an engine vehicle to ensure a space for the batteries. However, the seat height needs to be lowered in order to maintain the driver's eye point without changing the position of a vehicle ceiling. Therefore, the space between a seat cushion and the floor needs to be narrower than in the engine vehicle.

On the other hand, an occupant sitting on a rear seat located behind a front seat may want to take a relaxed posture of stretching out the feet by entering the feet below the front seat. However, if the space between the seat cushion of the front seat and the floor is narrow, there is a possibility that the feet placed below the seat cushion may hit electrical components (such as harnesses).

In particular, the harness member is often disposed in either the right or left region of the bottom surface of the seat cushion, and is therefore likely to be hit by the feet of the occupant.

Japanese Patent Application Laid-Open No. 2021-91346 discloses a technology for protecting electrical components installed below a seat cushion with a plate-shaped cover member to prevent feet of an occupant of a rear seat from touching the electrical components in an EV vehicle having a narrow space below the seat cushion.

### SUMMARY OF INVENTION

### Technical Problem

However, even in the case of the protection using the cover member, there is a possibility that a strong impact is applied when kicked by the feet and hence there is a limit when reducing damages to electrical components or the like. Further, when the electrical components or the like are covered with the cover member, the space below the seat cushion becomes even narrower and hence the foot entry becomes difficult. At the same time, the cover member is separately provided and hence the cost increases.

The present invention has been made in view of the above-described problems and an object thereof is to provide a conveyance seat in which a harness member below a seat cushion is suppressed from being kicked by feet of an occupant.

### Solution to Problem

According to the conveyance seat of the present invention, the above-described problems are solved by a conveyance seat equipped with a seat cushion on which an occupant sits, wherein the seat cushion includes a plate-shaped pressure receiving member that receives a load of the occupant and a harness member that is fixed to the pressure receiving member, and wherein at least a part of the harness member is disposed in a center region in the right to left direction on the rear end side of the pressure receiving member.

The feet of the occupant sitting on the rear seat are inserted to be biased to either the right or left side from behind the conveyance seat. Therefore, the possibility that the feet can enter the center region of the seat is less than the right and left regions. Conventionally, since the harness member disposed in either right or left region on the rear end side of the pressure receiving member is disposed in the center region in the right to left direction, the harness member is suppressed from being kicked by the feet of the occupant.

Further, the conveyance seat may further include a first harness engagement portion which engages the harness member with the pressure receiving member, and the first harness engagement portion may be disposed in a center region of the pressure receiving member in the right to left direction.

Since the first harness engagement portion that engages the harness member is disposed in the center region in the right to left direction, the harness member can be fixed to the center region and hence the harness member will not move to the right or left end. Accordingly, the harness member is suppressed from being kicked by the feet of the occupant.

Further, the conveyance seat may further include a seat back which is a backrest for the occupant, a back frame that constitutes a framework of the seat back includes a pair of right and left side frames, a lower frame which connects the lower parts of the pair of right and left side frames, and a second harness engagement portion which engages the harness member with the lower frame, and the second harness engagement portion may be disposed in a center region of the lower frame in the right to left direction.

Since the harness member is engaged by the second harness engagement portion disposed in the center region of the lower frame, the harness member does not hang down below the conveyance seat and is further suppressed from being kicked by the feet of the occupant.

Further, in the conveyance seat, a concave portion may be formed in a lower surface of the pressure receiving member to be recessed toward an upper surface side, and the first harness engagement portion may be disposed in the concave portion and engage the harness member.

Since the first harness engagement portion is disposed in the concave portion, the amount of the first harness engagement portion protruding toward the lower surface side is reduced, and hence the possibility that the first harness engagement portion is kicked by the feet of the occupant is reduced.

Further, in the conveyance seat, a wire may be inserted into the center of the pressure receiving member and the first harness engagement portion may be disposed to avoid the wire.

Since the first harness engagement portion is disposed to avoid the wire, the concave portion can be formed in the pressure receiving member, the amount of the first harness engagement portion protruding toward the lower surface side is reduced, and hence the possibility that the first harness engagement portion is kicked by the feet of the occupant is reduced.

Further, the conveyance seat may further include a buffer material provided at the rear end portion of the pressure receiving member and protecting the harness member.

Damage to the harness member can be reduced by protecting the harness member with the buffer member.

Further, in the conveyance seat, the seat cushion may include a pad member disposed on the pressure receiving member, and the buffer material that protects the harness member may be formed by a portion extending downward from the rear end of the pad member.

Since the buffer member is formed by the portion extending from the rear end portion of the pad member, damage to the harness portion can be reduced and the number of components can be reduced to reduce the manufacturing cost.

Further, in the conveyance seat, the harness member may be arranged on the upper surface side of the pressure receiving member.

Since the harness member is not exposed on the lower surface by arranging the harness member on the upper surface side of the pressure receiving member, the harness member can be suppressed from being kicked by the feet.

### Advantageous Effects of Invention

According to the present invention, conventionally, since the harness member disposed in either right or left region on the rear end side of the pressure receiving member is disposed in the center region in the right to left direction, the harness member is suppressed from being kicked by the feet of the occupant.

Further, according to the present invention, since the first harness engagement portion that engages the harness member is disposed in the center region in the right to left direction, the harness member can be fixed to the center region and hence the harness member will not move to the right or left end. Accordingly, the harness member is suppressed from being kicked by the feet of the occupant.

Further, according to the present invention, since the harness member is engaged by the second harness engagement portion disposed in the center region of the lower frame, the harness member does not hang down below the conveyance seat and is further suppressed from being kicked by the feet of the occupant.

Further, according to the present invention, since the first harness engagement portion is disposed in the concave portion, the amount of the first harness engagement portion protruding toward the lower surface side is reduced, and hence the possibility that the first harness engagement portion is kicked by the feet of the occupant is reduced.

Further, according to the present invention, since the first harness engagement portion is disposed to avoid the wire, the concave portion can be formed in the pressure receiving member, the amount of the first harness engagement portion protruding toward the lower surface side is reduced, and hence the possibility that the first harness engagement portion is kicked by the feet of the occupant is reduced.

Further, damage to the harness member can be reduced by protecting the harness member with the buffer member.

Further, according to the present invention, since the buffer member is formed by the portion extending from the rear end portion of the pad member, damage to the harness portion can be reduced and the number of components can be reduced to reduce the manufacturing cost.

Further, according to the present invention, since the harness member is not exposed on the lower surface by arranging the harness member on the upper surface side of the pressure receiving member, the harness member can be suppressed from being kicked by the feet.

### DESCRIPTION OF EMBODIMENTS

Hereinafter, the configuration of a conveyance seat according to a third embodiment of the present invention will be described with reference to the drawings. However, the embodiment described below is intended to facilitate understanding of the present invention and is not intended to limit the present invention. That is, the present invention can be modified or improved without departing from the spirit of the invention, and it goes without saying that the present invention includes equivalents thereof.

Further, in the following description, the contents regarding the materials, shapes and sizes of the seat components are merely examples and do not limit the present invention.

Furthermore, in the following description, the vehicle seat mounted on the vehicle will be given as an example of the conveyance seat, and a configuration example thereof will be described.

### <Vehicle Seat 201>

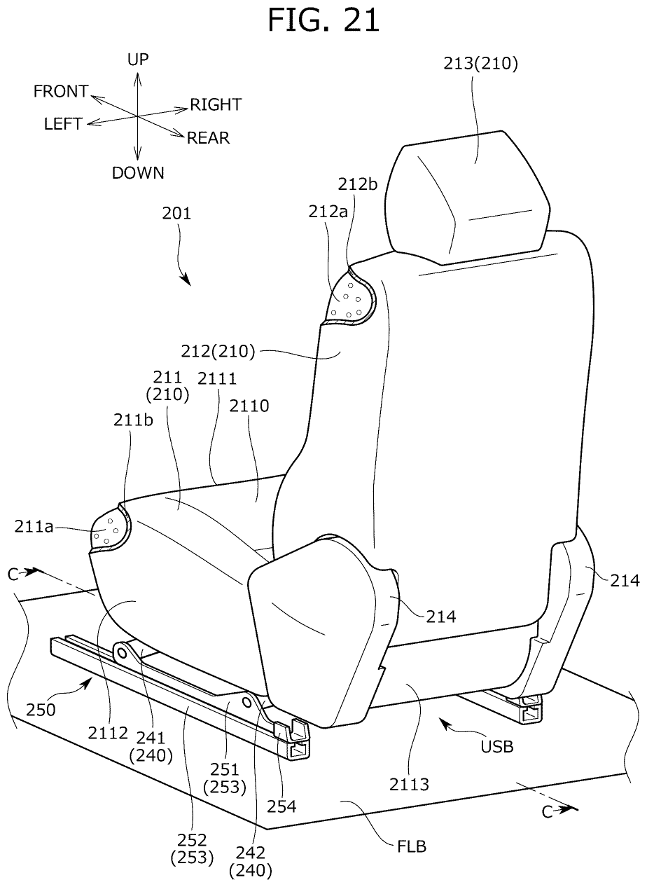

The basic configuration of the vehicle seat (hereinafter, vehicle seat 201) according to this embodiment will be described with reference to FIG. 21. FIG. 21 is a perspective view showing the vehicle seat 201 as viewed from the rear, and in FIG. 21, for convenience of illustration, a part of the vehicle seat 201 is shown with a cushion pad 211a, a back pad 212a, and cover materials 211b and 212b removed.

The vehicle seat 201 is a seat which is placed on a floor FLB in the vehicle compartment and on which an occupant of the vehicle sits. The vehicle seat 201 is used as the front seat of the vehicle. However, the present invention is not limited thereto, and the vehicle seat 201 can also be used as the rear seat located behind the front seat. Further, for example, in the vehicle with three rows of seats in the front to rear direction, the vehicle seat 201 can also be used as the middle seat in the second row.

In this embodiment, the vehicle seat 201 mainly includes a seat body 210, a height adjustment mechanism 240, and a slide mechanism 250 and is attached into the vehicle compartment of the vehicle.

The seat body 210 is attached at a predetermined height from the floor FLB of the vehicle compartment through the height adjustment mechanism 240 and the slide mechanism 250.

### <Seat Body 210>

As shown in FIG. 21, the seat body 210 mainly includes a seat cushion 211 which serves as a seating portion that supports the buttocks of the seated occupant, a seat back 212 which serves as a backrest that supports the back of the seated occupant, and a headrest 213 which is disposed at the upper part of the seat back 212 and supports the head of the seated occupant.

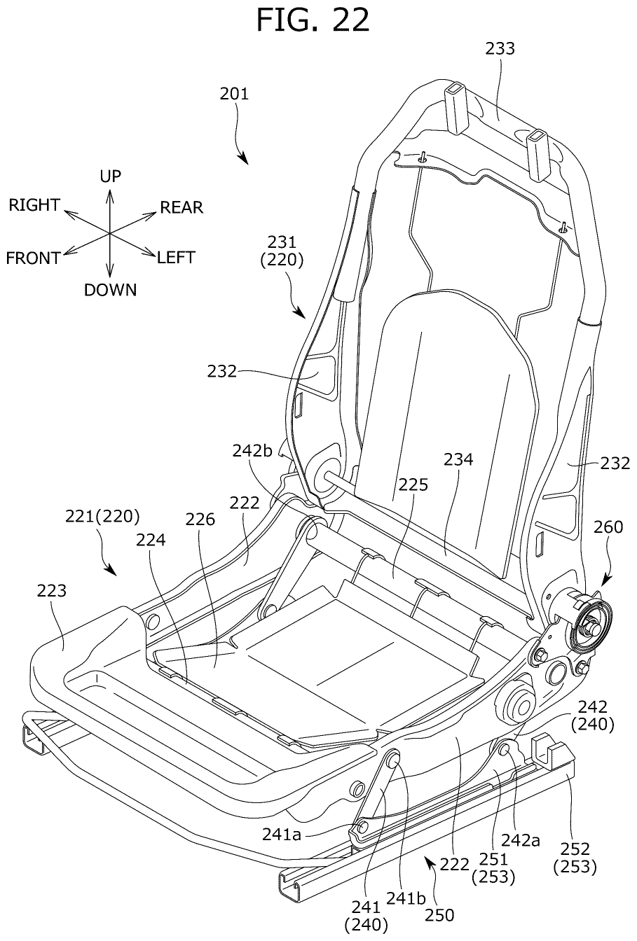

The seat cushion 211 is configured by covering a seat cushion frame 221 (see FIG. 22) with a cushion pad 211a (pad member) and a cover material 211b. The seat back 212 is configured by covering a seat back frame 231 (see FIG. 22) with a back pad 212a (pad member) and a cover material 212b. The headrest 213 is configured by covering a headrest frame with a pad and a cover material.

The cushion pad 211a and the back pad 212a are made of a urethane base material formed by foam molding using, for example, a urethane foam material, and the cover materials 211b and 212b are made of, for example, cloth, synthetic leather, genuine leather, or the like.

The seat cushion 211 and the seat back 212 are connected by a reclining mechanism 260 (see FIG. 22). The reclining mechanism 260 allows the seat back 212 to rotate relative to the seat cushion 211, and the inclination angle thereof can be adjusted.

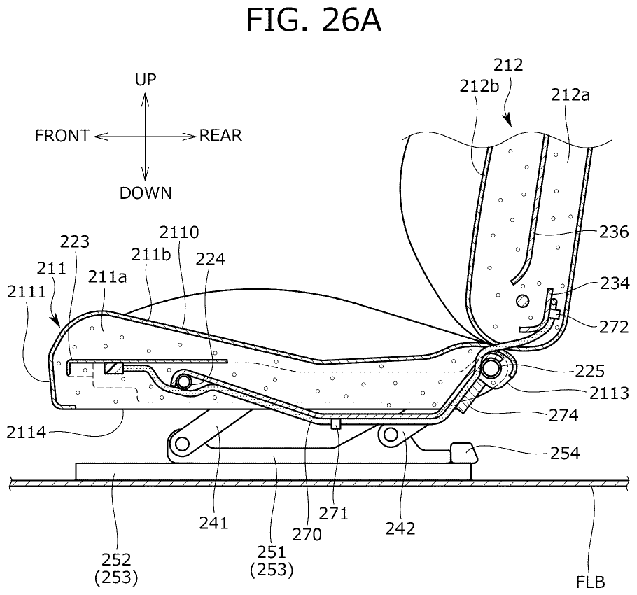

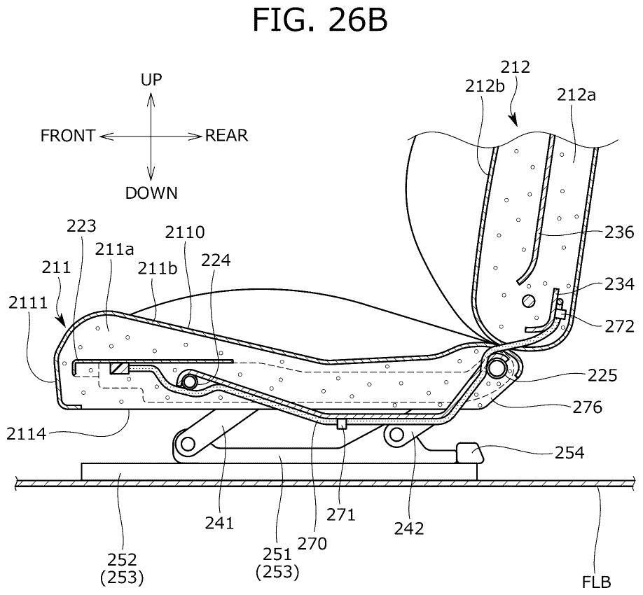

As for the description of the seat cushion 211 in more detail, the seat cushion 211 includes an upper surface portion 2110, a front surface portion 2111, right and left side surface portions 2112, a rear surface portion 2113, and a bottom surface portion 2114 (see FIG. 26A). The upper surface portion 2110 is a surface portion having a curved shape, and is a seating surface on which a seated occupant sits. The front surface portion 2111 extends downward while bulging forward from the front end portion of the upper surface portion 2110. The side surface portions 2112 extend downward from both sides of the upper surface portion 2110 in the seat width direction. The rear surface portion 2113 extends downward while being inclined forward from the rear end portion of the upper surface portion 2110. The upper surface portion 2110, the front surface portion 2111, the side surface portion 2112, and the rear surface portion 2113 are covered with the cover material 211b.

The bottom surface portion 2114 is located on the opposite side to the upper surface portion 2110 and forms the bottom surface of the seat cushion 211. The bottom surface portion 2114 is not covered with the cover material 211b. The seat cushion frame 221 (see FIG. 22) and a pressure receiving member 226 to be described later are exposed to the bottom surface portion 2114.

Further, a lower space USB is formed between the seat cushion 211 and the floor FLB below the seat body 210.

### <Seat Frame 220>

As shown in FIG. 22, a seat frame 220 is provided within the vehicle seat 201 as the framework thereof. The seat frame 220 includes the seat cushion frame 221 which forms the framework of the seat cushion 211 and the seat back frame 231 which forms the framework of the seat back 212.

### <Seat Cushion Frame 221>

The seat cushion frame 221 is formed in a rectangular frame shape, a pair of cushion side frames 222 are provided on the right and left sides thereof, and each cushion side frame 222 extends in the front to rear direction of the vehicle seat 201. Further, the seat cushion frame 221 includes a front pipe 224 that connects the pair of cushion side frames 222 and 222 at the front side and a rear pipe 225 that connects them at the rear side. The front pipe 224 and the rear pipe 225 at the front and rear of the vehicle seat 201 are formed by round pipes. Further, a pan frame 223 is provided on the further front side of the front pipe 224.

A front actuator and a rear actuator (not shown) that operate the movable portions (front link 241 and rear link 242 to be described later) of the height adjustment mechanism 240 are attached to the outer side surface of the left cushion side frame 222.

The seat cushion 211 is provided with a plate-shaped pressure receiving member 226 that receives a load from the buttocks of the seated occupant. As shown in FIG. 22, the pressure receiving member 226 is a plate-shaped member made of resin, and the cushion pad 211a is placed on the pressure receiving member 226.

The pressure receiving member 226 is provided across the front pipe 224 and the rear pipe 225 in the seat cushion frame 221. More specifically, wires 273 are inserted into the pressure receiving member 226 at the right and left end portions and the center to extend in the front to rear direction, and the pressure receiving member 226 is fixed to the front pipe 224 and the rear pipe 225 by hooks formed at the front and rear ends of the wires 273.

### <Seat Back Frame 231>

The seat back frame 231 is formed in a rectangular frame shape as a whole. The seat back frame 231 includes a pair of back side frames 232 and 232 which are arranged on the right and left, an upper frame 233, and a lower frame 234. The upper frame 233 is a connection member that is disposed between the pair of back side frames 232 and 232 and connects the upper ends of the pair of back side frames 232 and 232. The lower frame 234 is a connection member that is disposed between the pair of back side frames 232 and 232 and connects the lower ends of the pair of back side frames 232 and 232. The back side frame 232, the upper frame 233, and the lower frame 234 are formed by plate-shaped members.

### <Height Adjustment Mechanism 240>

The height adjustment mechanism 240 is disposed between the seat cushion frame 221 and an upper rail 251 constituting the slide mechanism 250 in the up to down direction. Then, when the occupant performs a height adjustment operation (for example, an operation of pressing a lift button (not shown)), the movable portion of the height adjustment mechanism 240 is operated by the front actuator and the rear actuator (not shown). Accordingly, the height of the vehicle seat 201 including the seat cushion 211 is adjusted.

The height adjustment mechanism 240 includes the front link 241 located at the front and the rear link 242 located at the rear. The front link 241 and the rear link 242 form a pair to adjust the height of the vehicle seat 201.

The front link 241 is formed by a metal plate member and has an elongated shape. One end portion of the front link 241 in the longitudinal direction is supported on the upper rail 251 to be swingable about a first swing shaft 241a. The other end portion of the front link 241 in the longitudinal direction is connected to the front actuator through a gear (not shown) and is attached to the cushion side frame 222 to be swingable about a second swing shaft 241b.

The rear link 242 is formed by a metal plate member and has an elongated shape. One end portion of the rear link 242 in the longitudinal direction is supported on the upper rail 251 to be swingable about a third swing shaft 242a. The other end portion of the rear link 242 in the longitudinal direction is connected to the rear actuator through a gear (not shown) and is attached to the cushion side frame 222 to be swingable about a fourth swing shaft 242b.

As for the operation of the height adjustment mechanism 240 with the above-described configuration, when an occupant as an occupant sitting on the seat performs a height adjustment operation, the front actuator and the rear actuator are driven, and the front link 241 and the rear link 242 swing.

In this way, the height adjustment mechanism 240 can adjust the overall height of the vehicle seat 201 including the seat cushion 211 by simultaneously swinging the front link 241 and the rear link 242, but the present invention is not limited thereto. By swinging only the rear link 242 to be upright without swinging the front link 241, the seat cushion 211 can be raised while tilting forward.

### <Slide Mechanism 250>

Further, as shown in FIGS. 21 and 22, the slide mechanism 250 is disposed below the vehicle seat 201. By means of this slide mechanism 250, the seat body 210 of the vehicle seat 201 is attached to the floor FLB to be slidable in the front to rear direction.

The slide mechanism 250 is a device for sliding the seat body 210 of the vehicle seat 201 along the front to rear direction and has a known structure (a structure of a general slide mechanism). The slide mechanism 250 includes a lower rail 252 fixed on the floor FLB and an upper rail 251 slidable relative to the lower rail 252 as a slide rail 253. The upper rail 251 connected to the seat body 210 is slidable relative to the lower rail 252 fixed on the floor FLB. Further, a foot cover 254 that protects the slide rail 253 is attached to the rear end portion of the slide rail 253, more specifically, the rear end portion of the lower rail 252.

The vehicle seat 201 is provided with electrical components such as the slide mechanism 250 and the height adjustment mechanism 240. The electrical components are supplied with power from a power source (not shown) so that the electrical components perform a predetermined operation or function. Other examples of electrical components include control devices such as in-vehicle ECUs (Electronic Control Units, hereinafter simply referred to as “ECUs”) and display devices. Examples of such detection devices include an occupant detection sensor attached to the vehicle seat 201. Further, examples of electrical components include temperature control mechanisms such as heaters and fans.

### <Harness Member 270>

A wire harness (hereinafter, referred to as a harness member 270) is provided to supply power to various electrical components provided in the vehicle seat 201 or to electrically connect the various electrical components to each other. The harness member 270 is coated with resin on the outside and has a metal core wire disposed therein. An electrical connection to electrical components provided in the vehicle seat 201 is ensured via the harness member 270.

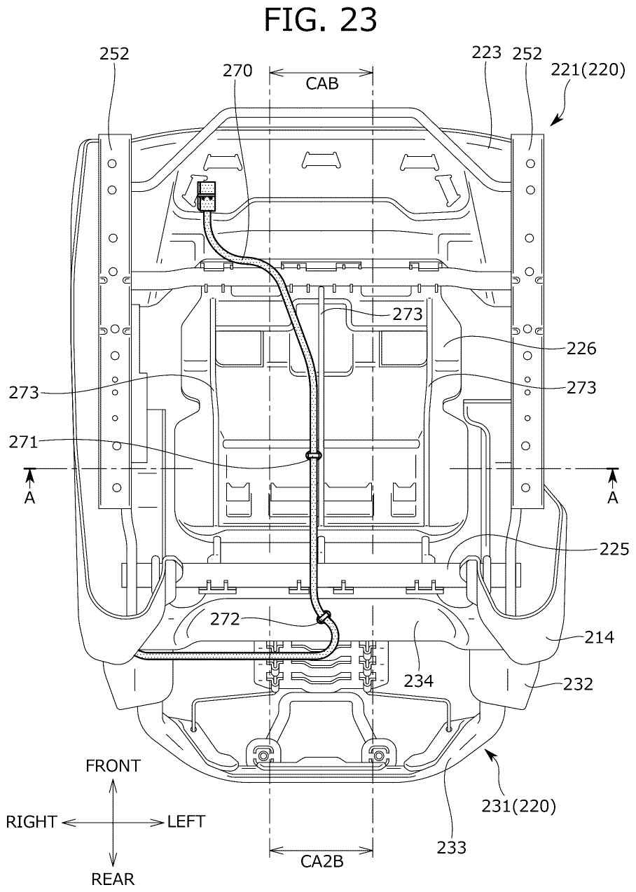

In the vehicle seat 201 of this embodiment, as shown in FIG. 23, the harness member 270 is disposed on the lower surface of the pressure receiving member 226. The harness member 270 connects, for example, an ECU mounted on the pan frame 223 and the reclining mechanism 260 provided at the lower end of the seat back 212.

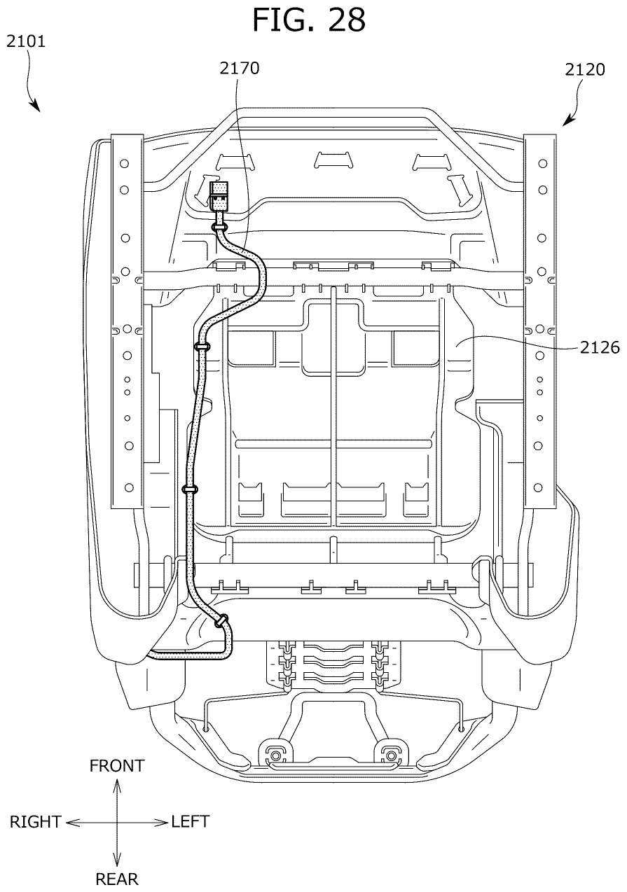

The arrangement of a conventional harness member 2170 will be described with reference to FIG. 28. FIG. 28 is a bottom view of a vehicle seat 2101 showing the arrangement of the conventional harness member 2170. As shown in FIG. 28, conventionally, the harness member 2170 is disposed on the right or left side of a pressure receiving member 2126 to extend in the front to rear direction.

However, when feet FTB are inserted into the lower space USB of the vehicle seat 2101, there is a high possibility that the foot will be inserted into the right or left region of the lower space. Therefore, when the harness member 2170 is disposed in the right or left region of the pressure receiving member 2126, there is a possibility that the harness member 2170 will be kicked when an occupant sitting at the rear of the vehicle seat 2101 enters the feet.

In the vehicle seat 201 of this embodiment, as shown in FIG. 23, at least a part of the harness member 270 is disposed in a center region CAB in the right to left direction (seat width direction) on the rear end side of the pressure receiving member 226 that may contact the feet FTB of the occupant.

Since both feet of the occupant are spaced apart from each other, there is a high possibility that the feet FTB are inserted to avoid the center region CAB of the pressure receiving member 226 in the right to left direction when the feet FTB are inserted. By disposing the harness member 270 in the center region CAB of the pressure receiving member 226, the possibility that the harness member 270 contacts the feet FTB of the occupant is reduced and hence the harness member 270 can be suppressed from being kicked by the feet FTB.

Furthermore, when the harness member 270 is disposed in the center region CAB, that is, a range having a constant width including the center in the right to left direction (seat width direction), the harness member may not be necessarily located at the center of the pressure receiving member 226 in the right to left direction. Furthermore, the constant width of the center region CAB is within a range defined by boundary lines spaced, for example, 1 to 7 cm, preferably about 3 cm, from the center axis of the pressure receiving member 226 in the front to rear direction and in the right to left direction.

The method of engaging the harness member 270 is not particularly limited. As an example, the harness member 270 is engaged with the lower surface of the pressure receiving member 226 through a snap type harness clip 271 (first harness engagement portion). The engagement of the harness member 270 means that the harness member 270 is attached to the extent that follows the displacement of the vehicle seat 201 and also means that the harness member 270 is fixed in a removable manner.

### <Harness Clip 271, 272>

The harness clip 271 is a resin member having a C-shaped cross section and capable of removably holding the harness member 270. The harness clip 271 is fixed by fitting the snap portion to a hole provided in the pressure receiving member 226 and the like.

The harness clip 271 is disposed in the center region CAB of the pressure receiving member 226 in the right to left direction. More specifically, the harness clip 271 is disposed in the vicinity of the wire 273 that is provided at the center of the pressure receiving member 226 and extends in the front to rear direction. By engaging the harness member 270 with the pressure receiving member 226 using the harness clip 271, the harness member 270 can be fastened to the center region CAB of the pressure receiving member 226 even when the vehicle seat 201 moves.

Further, as shown in FIG. 23, the harness member 270 may engage with the lower frame 234 that connects the lower parts of the pair of right and left side frames of the seat back frame 231 through a harness clip 272 (second harness engagement portion). The harness clip 272 that engages the harness member 270 is disposed in a center region CA2B of the lower frame 234 in the right to left direction (seat width direction). Therefore, the harness member 270 can be disposed in the center region CA2B in the right to left direction even at the lower end of the seat back frame 231. In other words, since the harness member 270 engages with the lower frame 234 using the harness clip 272, the harness member 270 is fastened to the center region CA2B of the lower frame 234 even when the vehicle seat 201 moves and hence the harness member 270 can be suppressed from being kicked by the feet FTB of the occupant.

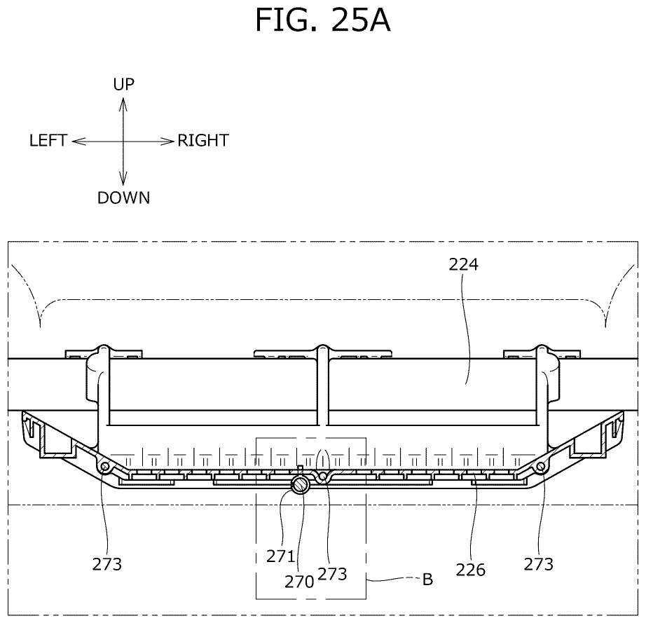

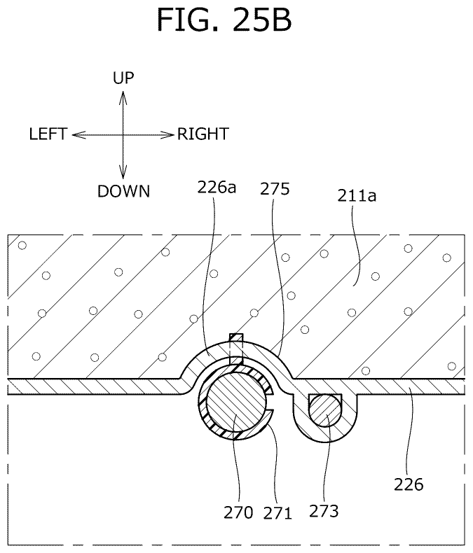

Further, as shown in FIG. 25B, a concave portion 226a may be formed in the lower surface of the pressure receiving member 226 to be recessed toward the upper surface side and the harness clip 271 may be disposed in the concave portion 226a to engage the harness member 270. By forming the concave portion 226a and disposing the harness clip 271, the height that the harness clip 271 protrudes downward can be reduced, and the possibility that the harness clip 271 will be kicked can be reduced. At this time, since the concave portion 226a is formed, a concave portion 275 may be formed in the cushion pad 211a in accordance with the protruding shape formed on the upper surface of the pressure receiving member 226. Further, the concave portion 226a may be formed not only at the position where the harness clip 271 is disposed, but also as a groove extending in the front to rear direction.

As described above, the plurality of wires 273 are inserted into the pressure receiving member 226. When the harness clip 271 is attached to the wire 273 located in the center region CAB among the plurality of wires 273 in an overlapping manner, the harness clip 271 protrudes further downward. Therefore, as shown in FIG. 25B, the harness clip 271 may be disposed to avoid the wire 273 in the center region CAB. That is, the harness clip may be disposed in a region in which the wire 273 is not disposed. Since the harness clip 271 is attached to the pressure receiving member 226 to avoid the wire 273, the height that protrudes toward the lower surface side of the pressure receiving member 226 is reduced, and the possibility that the harness member 270 and the harness clip 271 are kicked by the feet FTB of the occupant is reduced.

### <Buffer Material 274>

As shown in FIG. 26A, a buffer material 274 may be provided at the rear end portion of the pressure receiving member 226 to overlap the harness member 270. The buffer material 274 is formed by, for example, a buffer member such as carpet, urethane, and rubber. By providing the buffer material 274, damages to the harness member 270 caused by kicking up of the feet FTB can be reduced.

Further, the rear end portion 276 may function as the buffer material 274 in such a manner that the harness member 270 at the rear end portion of the pressure receiving member 226 is covered by extending the rear end portion 276 of the cushion pad 211a downward as shown in FIG. 26B without attaching the buffer material 274 as a separate member.

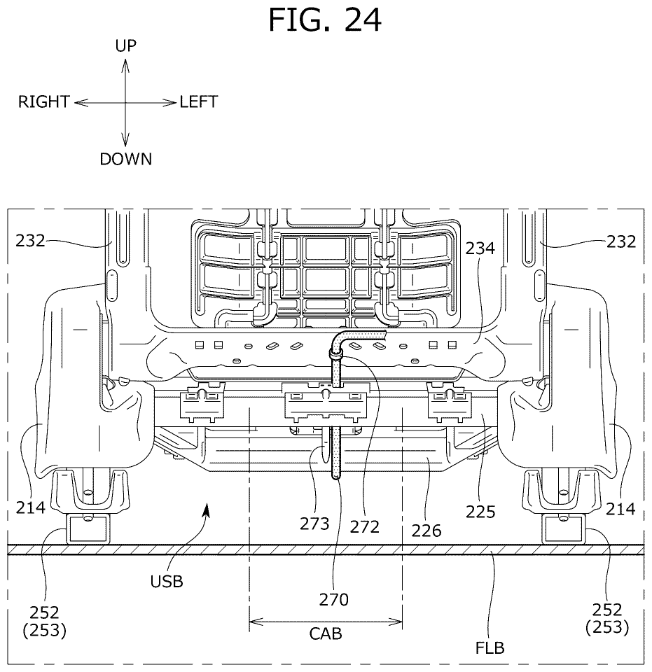

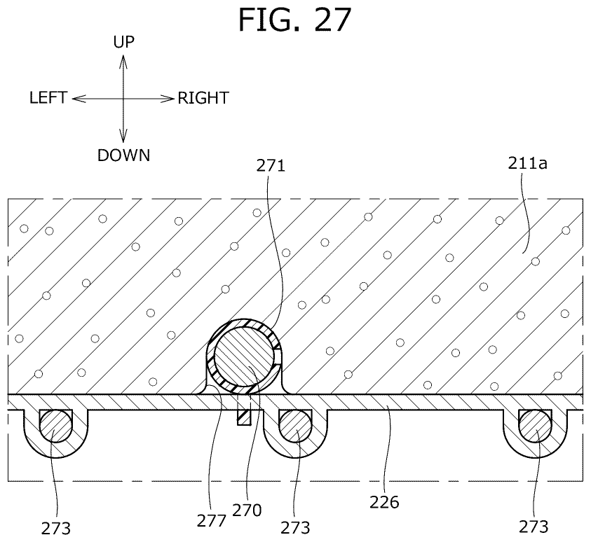

The harness member 270 shown in FIGS. 23 to 26B are provided on the lower surface side of the pressure receiving member 226, but the harness member 270 may be disposed on the upper surface side of the pressure receiving member 226 as shown in FIG. 27. In this case, a groove-shaped concave portion 277 may be formed in the cushion pad 211a of the pressure receiving member 226 in accordance with the position of the harness member 270. Further, the harness clip 271 may also fasten the harness member 270 from the upper surface side of the pressure receiving member 226.

By disposing the harness member 270 on the upper surface side of the pressure receiving member 226, the harness member 270 can be protected from kicking up of the feet FTB of the occupant.

As described above, the vehicle seat 201 according to the third embodiment of the present invention has been described with reference to the drawings. The vehicle seat 201 includes the slide mechanism 250 and the height adjustment mechanism 240, but the present invention can also be applied to the vehicle seat 201 without the slide mechanism 250 or the height adjustment mechanism 240. Further, the present invention can be applied not only to EV vehicles but also to gasoline vehicles.

### Fourth Embodiment

Hereinafter, a conveyance seat according to a fourth embodiment of the present invention will be described with reference to the drawings.

### TECHNICAL FIELD

A fourth embodiment relates to a conveyance seat and particularly to a conveyance seat that forms a space between a seat body and a floor.

### BACKGROUND ART

A vehicle seat is attached at a predetermined height from a floor and forms a space between the vehicle seat and the floor (hereinafter, this space is referred to as a lower space). Then, the vehicle seat includes a height mechanism that is able to adjust the height from the floor and can adjust the height of the vehicle seat to an optimum height for a seated occupant.

In this way, the lower space formed below the vehicle seat is used as an adjustment space for adjusting the height of the vehicle seat. At the same time, the lower space located behind the vehicle seat is used as a foot space for placing the feet of the occupant sitting on the vehicle seat in the rear row.

In a vehicle seat frame described in Japanese Patent Application Laid-Open No. 2020-59420, an empty space is formed in the lower space on both sides in the seat width direction by disposing a sliding mechanism at the center of the vehicle seat frame in the seat width direction. Accordingly, the interference between the feet and the sliding mechanism can be suppressed when the occupant sitting on the rear seat stretches out both feet and the space in front of both feet of the seated occupant can be increased.

### SUMMARY OF INVENTION

### Technical Problem

According to the technology described in Japanese Patent Application Laid-Open No. 2020-59420, the lower space of the conveyance seat can be used as the foot space of the seated occupant sitting on the rear seat. However, further improvements are desired in terms of effective utilization of the space below.

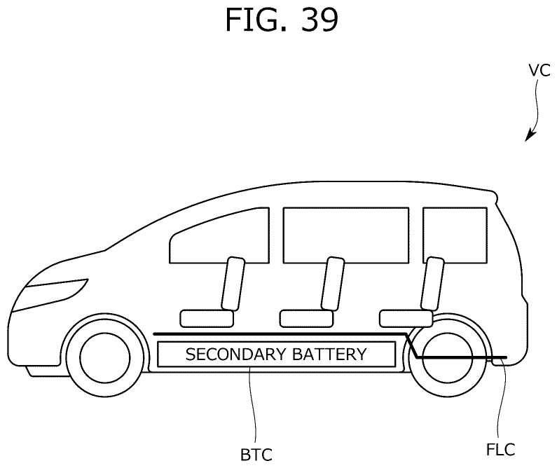

Specifically, as shown in FIG. 39, it has become common to place a secondary battery BT, which serves as a power source, below a floor with the recent spread of electric vehicles. Accordingly, the floor is positioned relatively high, and the space below the conveyance seat is becoming smaller in a limited vehicle interior space. Therefore, further improvements are desired in terms of effective utilization of the limited lower space.

The present invention has been made in view of the above-described problems and an object thereof is to provide a conveyance seat capable of effectively using a space between a seat body and a floor.

### Solution to Problem

According to the conveyance seat of the present invention, the above-described problems are solved by an electric conveyance seat including: a seat body which is attached at a predetermined height position from a conveyance floor and forms a space between the seat body and the floor, a drive mechanism which drives the seat body to move, and control means for controlling the drive mechanism, wherein the control means acquires a detection signal of an entry object entering the space and controls the drive mechanism so that the seat body is separated from the entry object based on the detection signal.

According to the above-described configuration, when the entry object entering the space between the seat body and the floor is detected, the seat body is driven and controlled to be separated from the entry object. Therefore, for example, when the feet of the seated occupant sitting on the rear seat enter the space between the seat body and the floor, the conveyance seat in the front row is driven upward or forward to be separated from the feet. Accordingly, the foot space of the seated occupant sitting on the rear seat is expanded and hence the limited lower space can be effectively used.

Further, the drive mechanism may be a lifting mechanism that drives the seat body in the up to down direction, and the control means may control the lifting mechanism to raise the seat body based on the detection signal.

According to the above-described configuration, when it is detected that the entry object has entered, the seat body is driven and controlled to be raised. Therefore, for example, when the feet of the seated occupant sitting on the rear seat enter the space between the seat body and the floor, the conveyance seat in the front row is driven upward to be separated from the feet. Accordingly, the foot space of the seated occupant sitting on the rear seat is expanded upward. As a result, it is possible to suppress damages to the conveyance seat due to the contact between the feet of the seated occupant sitting on the rear seat and electrical components, cables, and the like arranged below the seat body.

Further, the lifting mechanism may include a tiltable link member and the control means may control the lifting mechanism to raise the link member based on the detection signal.

According to the above-described configuration, since the lifting mechanism is configured by the link member that constitutes the height mechanism for adjusting the height position of the conveyance seat, it is not necessary to attach a dedicated lifting mechanism. Therefore, it is possible to suppress an increase in cost of the conveyance seat.

Further, the link member may include a rear link member and a front link member, and the control means may control the lifting mechanism to raise the rear link member and tilt the seat body forward based on the detection signal.

According to the above-described configuration, when the detection signal of the entry object is acquired, the seat body is driven and controlled to be tilted forward. Therefore, for example, when the feet of the seated occupant sitting on the rear seat enter the space between the seat body and the floor, the conveyance seat in the front row is driven forward to be separated from the feet. At this time, since it is not necessary to drive and control the front link member, it is possible to effectively use the lower space with smaller power compared to the case where the whole seat body is raised.

Further, the drive mechanism may be a sliding mechanism that drives the seat body back and forth, and the control means may control the sliding mechanism so that the seat body slides forward based on the detection signal.

According to the above-described configuration, when it is detected that the entry object has entered from behind, the seat body is driven and controlled to slide forward. Therefore, for example, when the feet of the seated occupant sitting on the rear seat enter the lower space, the conveyance seat in the front row is driven forward to be separated from the feet. Accordingly, the foot space of the seated occupant sitting on the rear seat is expanded forward. As a result, the seated occupant sitting on the rear seat can stretch out the feet by using the expanded foot space.

Further, the drive mechanism may be a rotation mechanism that rotates the seat body about a rotation axis extending in the up to down direction, and the control means may control the rotation mechanism so that the seat body rotates based on the detection signal.

According to the above-described configuration, when the detection signal of the entry object is acquired, the seat body is driven and controlled to rotate about a rotation axis extending in the up to down direction. Accordingly, for example, when the feet of the seated occupant sitting on the rear seat enter the space between the seat body and the floor, the conveyance seat in the front row rotates by 45°. Therefore, the foot space in front of both feet of the seated occupant sitting on the rear seat is expanded and the feet can be stretched out by using the expanded foot space.

Further, the control means may acquire a seating signal related to a seated state of the occupant and control the drive mechanism not to move the seat body based on the seating signal when the detection signal is acquired.

According to the above-described configuration, the conveyance seat does not move even when the entry object enters when the seated occupant is seated. Thus, since it is possible to suppress the conveyance seat from being inadvertently moved while the occupant is seated, the occupant does not feel uncomfortable.

Further, the control means may acquire a speed signal related to the conveyance speed and control the drive mechanism not to move the seat body based on the speed signal when the detection signal is acquired.

According to the above-described configuration, when the conveyance is traveling at a speed exceeding a predetermined speed, the conveyance seat does not move even when the entry object enters. Thus, since it is possible to suppress the conveyance seat from being inadvertently moved while the vehicle is traveling, the driver can concentrate on driving with peace of mind.

Further, the conveyance seat may include a non-contact or contact entry detection sensor which detects the entry object and outputs the detection signal.

According to the above-described configuration, since the entry detection sensor can detect the entry object without physically contacting the entry object, it is possible to suppress damages to the entry detection sensor due to the contact between the entry object and the entry detection sensor.

Further, the contact entry detection sensor detects the entry due to the physical contact. In other words, since the seated occupant sitting on the rear seat can expand the foot space by intentionally driving the conveyance seat so that the feet contact the contact sensor, convenience can be improved.

Further, the control means may acquire an abnormality detection signal related to the presence or absence of an abnormality in the conveyance seat and control the drive mechanism not to move the seat body based on the abnormality detection signal when the detection signal is acquired.

According to the above-described configuration, since it is possible to suppress the conveyance seat from being inadvertently driven due to the occurrence of an abnormality, the seated occupant does not feel uncomfortable.

### Advantageous Effects of Invention

According to the present invention, it is possible to provide the conveyance seat capable of effectively using the space formed between the seat body and the floor.

Further, according to the present invention, it is possible to suppress damages to the conveyance seat due to the contact between the feet of the seated occupant sitting on the rear seat and electrical components, cables, and the like arranged below the seat body.

Further, according to the present invention, it is possible to suppress an increase in cost of the conveyance seat.

Further, according to the present invention, it is possible to effectively use the lower space with smaller power.

Further, according to the present invention, the foot space in front of both feet of the seated occupant sitting on the rear seat is expanded and the feet can be stretched out by using the expanded foot space.

Further, according to the present invention, since it is possible to suppress the conveyance seat from being inadvertently driven in a seated state, the seated occupant does not feel uncomfortable.

Further, according to the present invention, since it is possible to suppress the conveyance seat from being inadvertently driven while the vehicle is traveling, the driver can drive the vehicle with peace of mind.

Further, according to the present invention, damages of the entry detection sensor can be suppressed.

Further, according to the present invention, since the seated occupant sitting on the rear seat can expand the foot space by intentionally driving the conveyance seat so that the feet contact the contact sensor, convenience can be improved.

### DESCRIPTION OF EMBODIMENTS

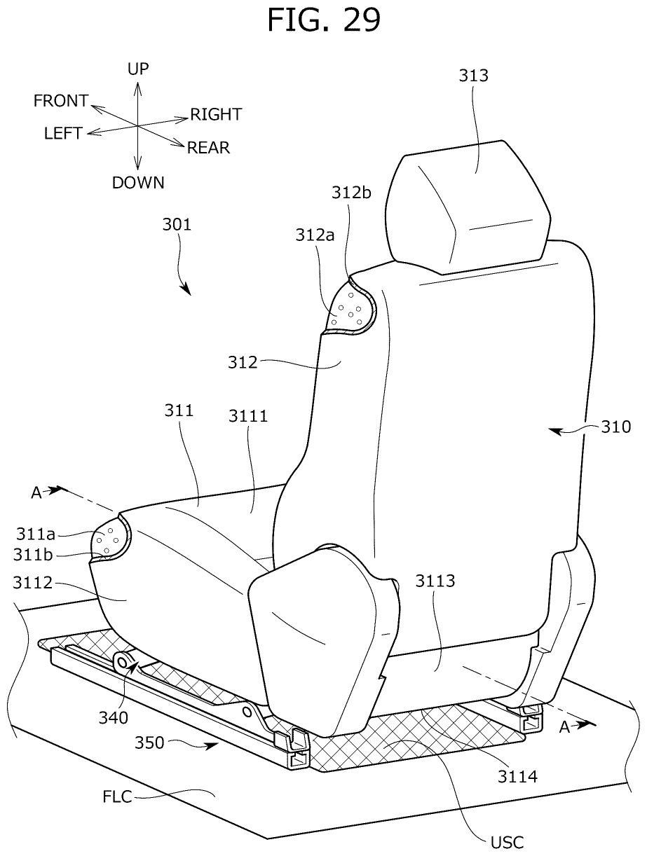

Hereinafter, a conveyance seat according to a fourth embodiment (hereinafter, this embodiment) of the present invention will be described with reference to FIGS. 29 to 39.

### First Example of Fourth Embodiment

This embodiment relates to the invention of an electric conveyance seat including: a seat body which is attached at a predetermined height position from a floor and forms a space between the seat body and the floor; a drive mechanism which drives the seat body to move; and control means for controlling the drive mechanism, wherein the control means acquires a detection signal of an entry object entering the space, and wherein the control means controls the drive mechanism to separate the seat body from the entry object based on the detection signal. Furthermore, in the following embodiments, an example in which the conveyance seat according to the present invention is applied to the vehicle seat will be described.

### <<Main Configuration of Vehicle Seat 301>>

First, the basic configuration of a vehicle seat 301 according to this embodiment will be described with reference to FIG. 29. As shown in FIG. 29, the electric vehicle seat 301 mainly includes a seat body 310, a height adjustment mechanism 340, and a slide mechanism 350 and is attached to the vehicle compartment of the conveyance. The vehicle seat 301 can move the seat body 310 in the up to down direction and the front to rear direction relative to the floor FLC of the vehicle compartment by the height adjustment mechanism 340 and the slide mechanism 350.

The seat body 310 includes a seat cushion 311, a seat back 312, and a headrest 313.

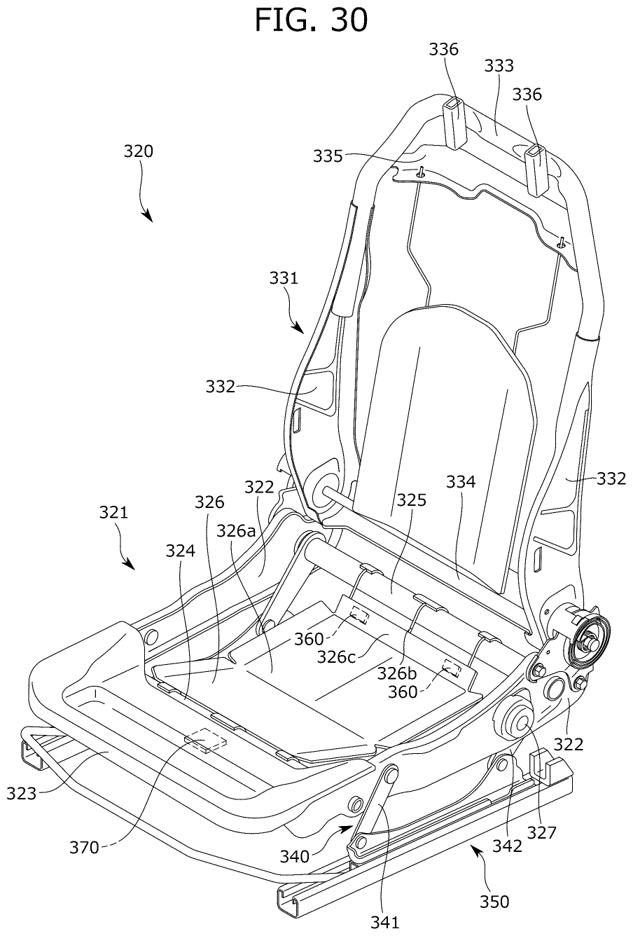

The seat cushion 311 is configured by covering a seat cushion frame 321 (see FIG. 30) with a seat cushion pad 311a and a cover material 311b. The seat back 312 is configured by covering a seat back frame 331 (see FIG. 30) with a seat back pad 312a and a cover material 312b. The headrest 313 is configured by covering a headrest frame (not shown) with a pad and a cover material (not shown).

The seat cushion 311 includes an upper surface portion 3111, a front surface portion (not shown), right and left side surface portions 3112, a rear surface portion 3113, and a bottom surface portion 3114. The upper surface portion 3111 is a surface portion having a curved shape, and is a seating surface on which a seated occupant sits. The front surface portion extends downward while bulging forward from the front end portion of the upper surface portion 3111. The side surface portions 3112 extend downward from both sides of the upper surface portion 3111 in the seat width direction. The rear surface portion 3113 extends downward while being inclined forward from the rear end portion of the upper surface portion 3111. The upper surface portion 3111, the front surface portion, the side surface portion 3112, and the rear surface portion 3113 are covered with the cover material 311b.

The bottom surface portion 3114 faces the upper surface portion 3111 and forms the bottom surface of the seat cushion 311. The bottom surface portion 3114 is not covered with the cover material 311b. Therefore, a seat cushion frame 321 (see FIG. 30) and a pressure receiving member 326 to be described later are exposed from the bottom surface portion 3114.

A lower space USC is formed between the seat body 310 and the floor FLC. The lower space USC is a space formed between the seat cushion 311 and the floor FLC. In other words, the lower space USC is located between the right and left side surface portions 3112 in the seat width direction and is located between the front surface portion and the rear surface portion 3113 in the front to rear direction.

As shown in FIG. 30, the vehicle seat 301 includes a vehicle seat frame 320 as the framework thereof. The vehicle seat frame 320 mainly includes the seat cushion frame 321 and the seat back frame 331.

The vehicle seat frame 320 is fixed to the slide mechanism 350, which slides the vehicle seat 301 in the front to rear direction, through the height adjustment mechanism 340.

The seat cushion frame 321 includes cushion side frames 322 serving as side frames, a pan frame 323, and front and rear pipes 324 and 325 serving as connection pipes.

Each of the cushion side frames 322 is disposed on the right and left sides of the seat cushion frame 321. Each cushion side frame 322 extends in the front to rear direction.

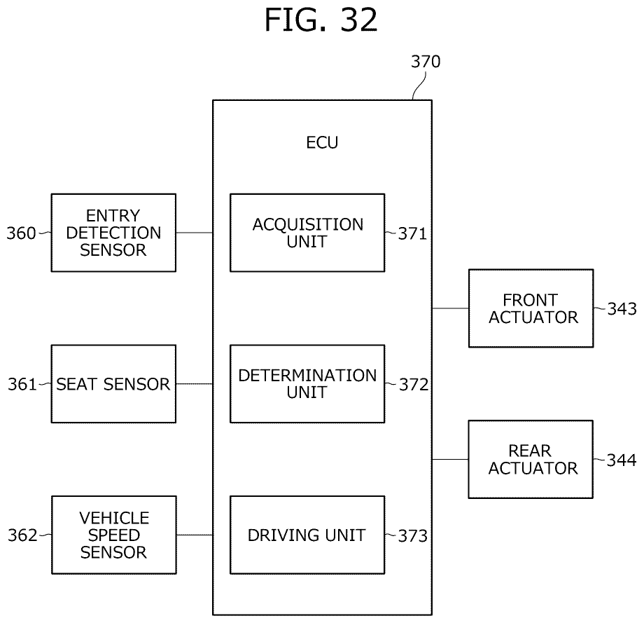

A front actuator 343 (see FIG. 32) and a rear actuator 344 which operate the movable portions (front link 341 and rear link 342 to be described later) of the height adjustment mechanism 340 are attached to the outer side surface of the left cushion side frame 322.

The pan frame 323 and the front pipe 324 are interposed in front of the right and left cushion side frames 322 and connect the right and left cushion side frames 322. A control device 370 is attached to the center of the pan frame 323 in the seat width direction.

The rear pipe 325 is a pipe-shaped body that is interposed between the right and left cushion side frames 322 behind the cushion side frame 322. The rear pipe 325 connects the right and left cushion side frames 322.

The pressure receiving member 326 is disposed between the right and left cushion side frames 322. The pressure receiving member 326 is a member that receives the load of the seated occupant through the seat cushion pad 311a. The pressure receiving member 326 includes a pressure receiving plate 326a and an elastic spring 326b that supports the pressure receiving plate 326a.

An inclined portion 326c that is inclined upward is formed at the rear end portion of the pressure receiving plate 326a. An entry detection sensor 360 to be described later is attached to the inclined portion 326c.

The seat back frame 331 includes a back side frame 332, an upper frame 333, and a lower frame 334.

Each of the back side frames 332 is disposed on the right and left sides of the seat back frame 331. The back side frame 332 extends in the up to down direction. The back side frame 332 is formed by a plate-shaped member.

The upper frame 333 connects the upper end portions of the right and left back side frames 332. The upper frame 333 is formed by a pipe-shaped member.

The lower frame 334 connects the lower end portions of the right and left back side frames 332. The upper frame 333 and the lower frame 334 extend in the right to left direction. The lower frame 334 is formed by a plate-shaped member.

The horizontal connection frame 335 connects the upper parts of the right and left back side frames 332. The horizontal connection frame 335 extends in the seat width direction. The horizontal connection frame 335 is formed by a plate-shaped member.

Further, the seat back frame 331 includes a pillar attachment member 336 for attaching the pillar of the headrest 313 at the center portion of the upper frame 333 in the seat width direction.

### <<Height Adjustment Mechanism 340>>

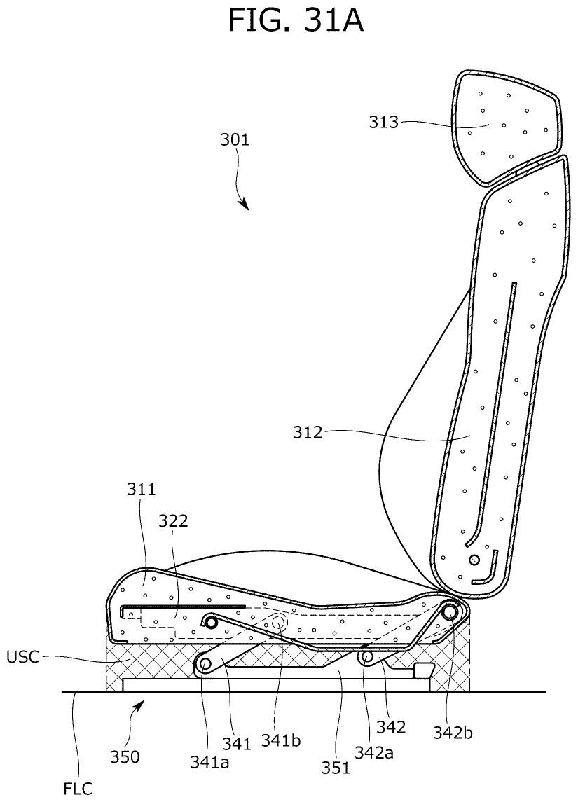

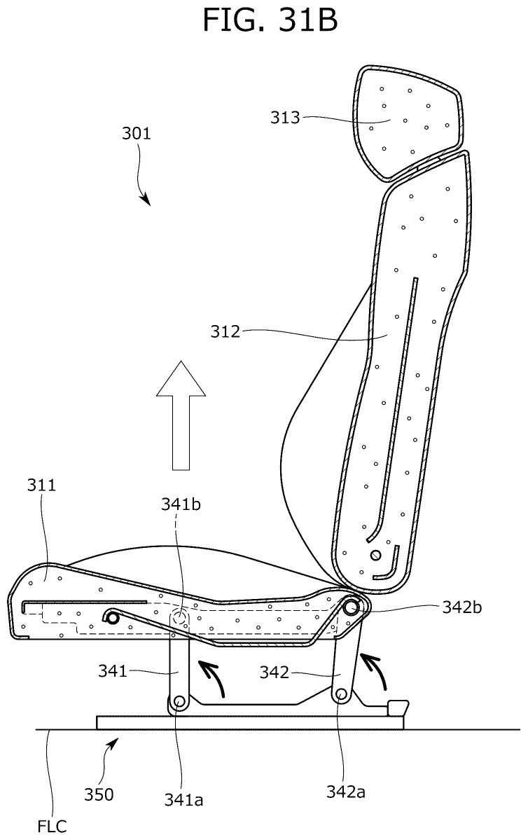

Hereinafter, the height adjustment mechanism 340 will be described with reference to FIGS. 31A and 31B. FIGS. 31A and 31B are views of the height adjustment mechanism 340 as viewed from the inside of the seat width direction.

The height adjustment mechanism 340 is disposed between the seat cushion 311 and an upper rail 351 constituting the slide mechanism 350 in the up to down direction. Then, when the occupant performs a height adjustment operation (for example, an operation of pressing a lift button (not shown)), the movable portion of the height adjustment mechanism 340 is operated by the front actuator 343 and the rear actuator 344. Accordingly, the height of the vehicle seat 301 including the seat cushion 311 is adjusted.

The height adjustment mechanism 340 includes the front link 341 located at the front and the rear link 342 located at the rear. The front link 341 and the rear link 342 form a pair to adjust the height of the vehicle seat 301. The front link 341 corresponds to the front link member of the present invention and the rear link 342 corresponds to the rear link member of the present invention. The height adjustment mechanism 340 corresponds to the lifting mechanism of the present invention.

The front link 341 is formed by a metal plate member and has an elongated shape. One end portion of the front link 341 in the longitudinal direction is supported on the upper rail 351 to be swingable about a first swing shaft 341a. The other end portion of the front link 341 in the longitudinal direction is connected to the front actuator 343 through a gear (not shown) and is attached to the cushion side frame 322 to be swingable about a second swing shaft 341b.

The rear link 342 is formed by a metal plate member and has an elongated shape. One end portion of the rear link 342 in the longitudinal direction is supported on the upper rail 351 to be swingable about a third swing shaft 342a. The other end portion of the rear link 342 in the longitudinal direction is connected to the rear actuator 344 through a gear (not shown) and is attached to the cushion side frame 322 to be swingable about a fourth swing shaft 342b.

The operation of the height adjustment mechanism 340 with the above-described configuration will be described. The height adjustment mechanism 340 performs a height adjustment operation of adjusting the overall height of the vehicle seat 301 by driving the front link 341 and the rear link 342 and a foot space adjustment operation of expanding the lower space USC located behind the vehicle seat 301 just by driving the rear link 342 (the foot space of the seated occupant sitting on the rear seat).

First, the height adjustment operation will be described. When the seated occupant sitting on the seat performs the height adjustment operation, the front actuator 343 and the rear actuator 344 are driven. Then, the front link 341 and the rear link 342 which respectively mesh with the front actuator 343 and the rear actuator 344 through gears swing. Accordingly, the cushion side frame 322 moves up and down between a lowered position shown in FIG. 31A and a raised position shown in FIG. 31B to adjust the height of the vehicle seat 301.

In this way, the height adjustment mechanism 340 can adjust the overall height of vehicle seat 301 including the seat cushion 311 by simultaneously swinging the front link 341 and the rear link 342.

Although the foot space adjustment operation will be described in detail later, the height adjustment mechanism 340 can enable the foot space adjustment operation in addition to the height adjustment operation of the vehicle seat 301. In this way, since it is not necessary to attach a dedicated lifting mechanism for the foot space adjustment operation, it is possible to suppress an increase in cost of the vehicle seat 301.

### <<Functional Configuration of Vehicle Seat 301>>

Next, the functional configuration of the vehicle seat 301 will be described. FIG. 32 is a block diagram showing the functional configuration of the vehicle seat 301. The vehicle seat 301 includes the entry detection sensor 360, a seat sensor 361, and the control device 370 which controls the front actuator 343 and the rear actuator 344 based on a detection value of a vehicle speed sensor 362. The control device 370 may be an ECU (Electronic Control Unit) (see FIG. 30) attached to the pan frame 323.

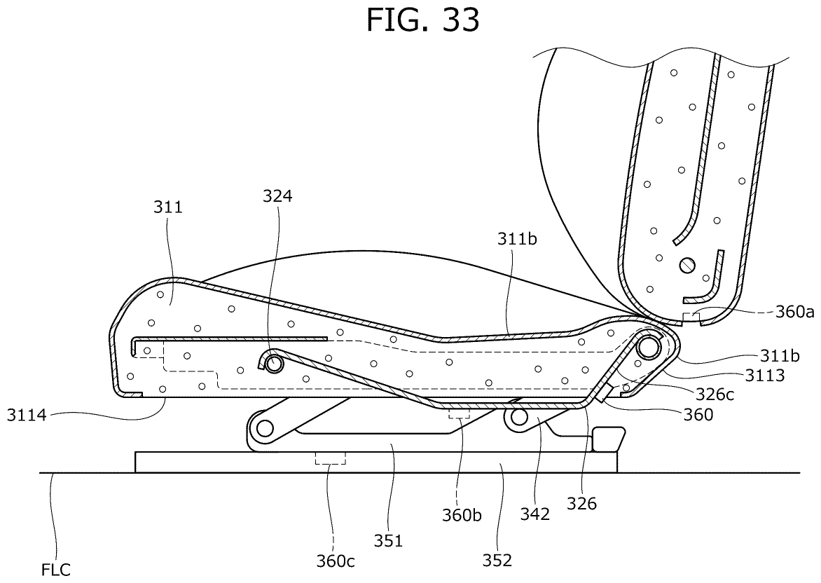

As shown in FIG. 33, the entry detection sensor 360 is attached to the vicinity of the rear surface portion 3113 and the bottom surface portion 3114 of the seat cushion 311. Specifically, the entry detection sensor 360 is disposed between the cover material 311b that covers the inclined portion 326c and the inclined portion 326c of the pressure receiving member 326 located in the vicinity of the rear surface portion 3113 and the bottom surface portion 3114 of the seat cushion 311.

The entry detection sensor 360 is an infrared sensor that functions as a human detection sensor, and is configured to receive infrared rays emitted by feet FTC of the seated occupant sitting on the rear seat and output a detection signal. A light receiving unit (not shown) of the entry detection sensor 360 is exposed without being covered by the cover material 311b at the lower end of the rear surface portion 3113.

By disposing the entry detection sensor 360 on the rear surface portion 3113 of the seat cushion 311 in this way, it is possible to quickly detect when the feet FTC of the seated occupant sitting on the rear seat enter the lower space USC from behind the vehicle seat 301.

Furthermore, the entry detection sensor 360 may be disposed at a second attachment position 360a of FIG. 33. Specifically, the entry detection sensor 360 may be disposed so that only the detection portion of the entry detection sensor 360 at the lower end of the seat back 312 is exposed without being covered by the cover material 311b. Accordingly, it is possible to detect the entry object entering the lower space USC from behind at an earlier stage.

Furthermore, the entry detection sensor 360 is not limited to the infrared sensor. The entry detection sensor 360 may be, for example, a camera capable of detecting visible light and capturing an image of the lower space USC. By using a camera as the entry detection sensor 360, it is also possible to detect when an object that does not emit infrared rays (such as an object inadvertently dropped by the seated occupant sitting on the rear seat) enters the lower space USC. In this case, the camera is preferably disposed at the position indicated by reference numeral 360 or 360a in FIG. 33. Accordingly, it is possible to quickly detect the entry object entering the lower space USC from behind.

Further, the entry detection sensor 360 may be a radar sensor that detects the entry object by transmitting microwaves and receiving the reflected waves. In particular, it is possible to detect the entry object and the entering speed of the entry object by adopting a Doppler radar sensor as the entry detection sensor 360. At this time, the control device 370 to be described later may control the rear link 342 based on the entering speed of the entry object. When the radar sensor is adopted as the entry detection sensor 360, the entry detection sensor 360 is preferably disposed at a third attachment position 360b or a fourth attachment position 360c of FIG. 33. Specifically, the radar sensor is disposed on the pressure receiving member 326 exposed to the bottom surface portion 3114 of the seat cushion 311 or the lower rail 352 of the slide mechanism 350. By disposing the radar sensor at a position directly facing the entering direction of the entry object in this way, it is possible to accurately detect the entering speed of the entry object.

The above-described infrared sensor, camera, and radar sensor are all non-contact entry detection sensors 360. By adopting the non-contact sensor as the entry detection sensor 360 in this way, the entry detection sensor 360 can detect the entry object without physically contacting the entry object. Accordingly, it is possible to suppress damages to the entry detection sensor 360 due to the contact between the entry object and the entry detection sensor 360.

Returning to FIG. 32, the seat sensor 361 is attached to the upper surface portion 3111 of the seat cushion 311. Specifically, the seat sensor 361 is disposed between the seat cushion pad 311a and the cover material 311b of the upper surface portion 3111 of the seat cushion 311. Then, the seat sensor 361 detects the load acting on the upper surface portion 3111 of the seat cushion 311. The control device 370 can determine the seated state (the presence or absence of the seated occupant) based on the detection value (corresponding to the seating signal) of the seat sensor 361.

The vehicle speed sensor 362 is provided in a vehicle VC and detects the traveling speed of the vehicle VC. The control device 370 can determine whether or not the vehicle VC is traveling based on the detection value (corresponding to the speed signal) of the vehicle speed sensor 362.

The control device 370 includes an acquisition unit 371, a determination unit 372, and a driving unit 373. The control device 370 functions as the acquisition unit 371, the determination unit 372, and the driving unit 373 by loading programs stored in a non-volatile memory (not shown) and executing the programs using a processor (not shown), which is a hardware resource.

The acquisition unit 371 acquires detection values of various sensors. Specifically, the acquisition unit 371 acquires the output of the entry detection sensor 360, the seat sensor 361, and the vehicle speed sensor 362. The acquisition unit 371 includes an ADC (analog-to-digital converter) and can convert analog signals output by various sensors into digital signals. Further, the acquisition unit 371 also includes a noise removal filter, and can improve the signal-to-noise ratio (S/N ratio) by removing signals in a frequency band consisting of noise components.

The determination unit 372 determines the state of the vehicle seat 301 based on the detection value acquired by the acquisition unit 371. Specifically, the determination unit 372 determines the presence or absence of the entry object (detects the entry object) based on the output signal of the entry detection sensor 360. The determination unit 372 may determine the presence or absence of the entry object by comparing the output signal of the entry detection sensor 360 with a predetermined threshold value. The determination unit 372 may determine the presence or absence of the entry object by comparing a change over time in the output signal of the entry detection sensor 360 with a predetermined threshold value.

The determination unit 372 can determine whether or not the seated occupant is sitting on the vehicle seat 301 based on the output signal of the seat sensor 361. Then, the determination unit 372 can determine whether or not the vehicle VC is traveling based on the output signal of the vehicle speed sensor 362.

The determination unit 372 may determine whether or not sensors are abnormal by acquiring the output signals of various sensors arranged in the vehicle VC as the abnormality detection signals. For example, the determination unit 372 may determine a failure of a sensor and a break in a cable connecting the sensor and the control device 370 based on output signals from various sensors.

The determination unit 372 may determine whether or not there is an abnormality in the drive mechanism including the front actuator 343 and the rear actuator 344.

The driving unit 373 controls the front actuator 343 and the rear actuator 344 so that the front link 341 and the rear link 342 rotate based on the determination result of the determination unit 372. In other words, the driving unit 373 performs the height adjustment operation and the foot space adjustment operation.

### <<Foot Space Adjustment Operation>>

Next, the foot space adjustment operation will be described. When no seated occupant sits on the vehicle seat 301 and an entry object enters the lower space USC from behind while the vehicle VC is not traveling, the foot space adjustment operation is performed. Accordingly, the rear link 342 rotates and the vehicle seat 301 can be raised while tilting the seat cushion 311 forward. Therefore, the foot space of the seated occupant sitting on the rear seat can be expanded upward.

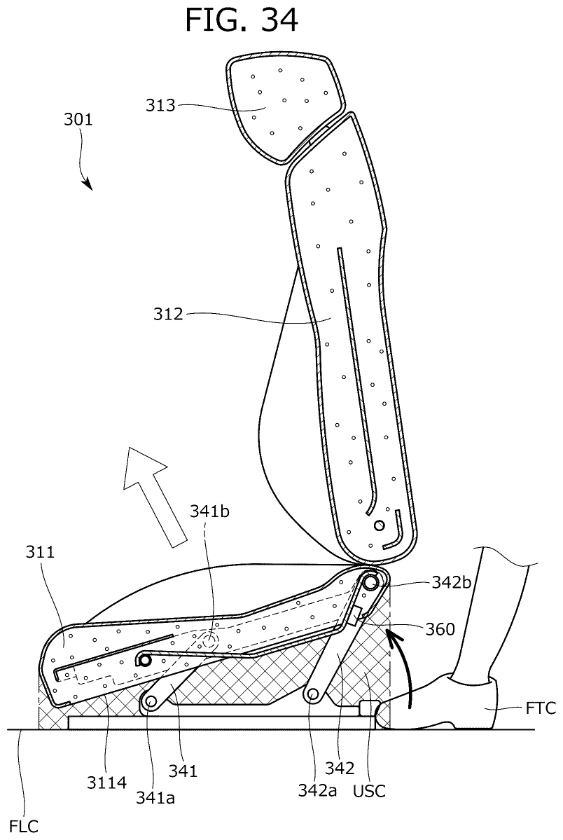

FIG. 34 shows the vehicle seat 301 in a state in which the rear link 342 has been rotated to be upright. As shown in FIG. 34, when the entry object (for example, the feet FTC of the seated occupant sitting on the rear seat) entering the lower space USC from behind the vehicle seat 301 is detected, the control device 370 rotates the rear link 342 so that the seat body 310 is driven to be separated from the feet FTC. In other words, the control device 370 controls the rear link 342 to raise the seat body 310. Hereinafter, this will be described in detail.

As shown in FIG. 34, the feet FTC of the seated occupant sitting on the rear seat are placed on the floor FLC. Then, when the seated occupant sitting on the rear seat stretches out the feet FTC forward, the feet FTC enter the lower space USC of the vehicle seat 301 in the front row from behind. At this time, the entry detection sensor 360 of the vehicle seat 301 detects the entry of the feet FTC. When the entry detection sensor 360 is the infrared sensor, the entry detection sensor 360 detects infrared rays emitted from the feet FTC.

The acquisition unit 371 acquires the output signals of the entry detection sensor 360, the seat sensor 361, and the vehicle speed sensor 362. Then, the determination unit 372 determines whether or not the feet FTC have entered the lower space USC from behind based on the signal acquired by the acquisition unit 371.

When the determination unit 372 determines that the feet FTC have entered the lower space USC from behind, the driving unit 373 rotates the rear link 342 to be upright. Accordingly, the seat body 310 rises to be separated from the feet FTC entering from behind. As a result, since the foot space is expanded upward, the seated occupant sitting on the rear seat can take a relaxed posture by using the expanded foot space. Further, it is possible to suppress damages to the vehicle seat 301 due to the contact between the feet FTC of the seated occupant sitting on the rear seat and electrical components, cables, and the like exposed to the bottom surface portion 3114 of the seat body 310.

Here, the driving unit 373 may control the rear link 342 not to rotate when the determination unit 372 determines that seated occupant is sitting on the vehicle seat 301. Accordingly, it is possible to suppress the seated occupant from feeling uncomfortable due to the sudden rising of the vehicle seat 301 while the vehicle seat 301 is in a seated state.

Further, the driving unit 373 may control the rear link 342 not to rotate when the determination unit 372 determines that the vehicle VC travels at a speed exceeding a predetermined threshold value (for example, 0 km/h). Accordingly, since it is possible to suppress the vehicle seat 301 from being inadvertently driven while the vehicle VC is traveling, the driver can concentrate on driving with peace of mind.

### Second Example

Although the configuration of the vehicle seat 301 according to the first example of the fourth embodiment has been described above, the above-described embodiment is merely an example for facilitating understanding of the present invention, and is not intended to limit the present invention. That is, the present invention can be modified or improved without departing from the spirit of the invention, and it goes without saying that the present invention includes equivalents thereof.

Next, a second example of the fourth embodiment will be described. In the above-described first example, it has been described that the rear link 342 is driven and controlled by the control device 370 to raise the seat body 310 when detecting that the entry object enters the lower space USC from behind. In contrast, a control device 370A according to the second example drives and controls the slide mechanism 350 so that the seat body 310 slides forward. Accordingly, since the seat body 310 is driven in a direction separated from the feet FTC of the seated occupant sitting on the rear seat, the foot space is expanded in front of the feet FTC and the seated occupant can effectively use the expanded foot space.

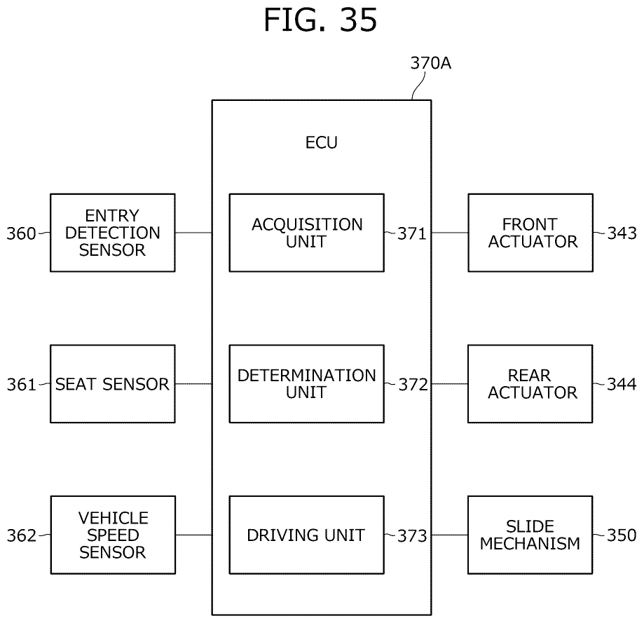

FIG. 35 is a block diagram showing the functional configuration of the vehicle seat 301 according to the second example. The vehicle seat 301 includes the entry detection sensor 360, the seat sensor 361, and the control device 370A which controls the slide mechanism 350 based on the detection signal of the vehicle speed sensor 362. The slide mechanism 350 will be described.

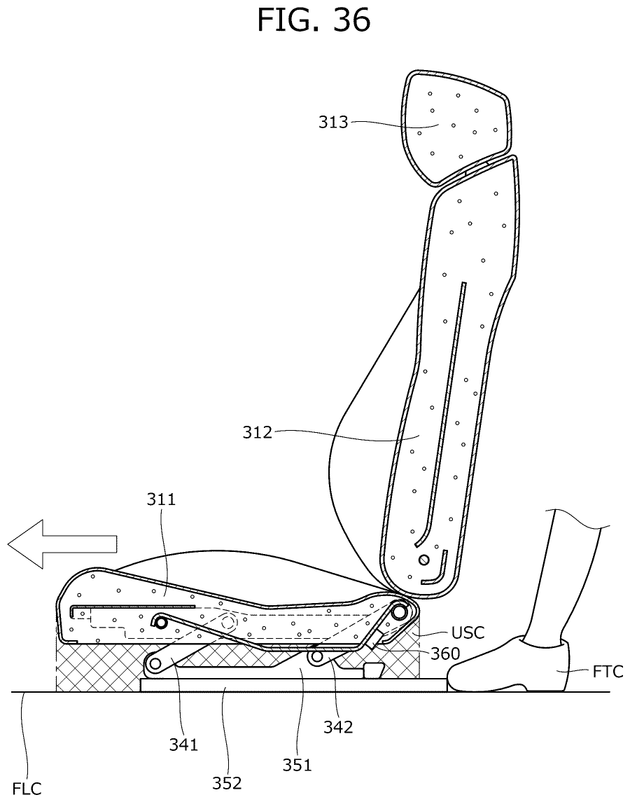

FIG. 36 shows the vehicle seat 301 in a state in which the seat body 310 has been slid by the slide mechanism 350. As shown in FIG. 36, when the feet FTC of the seated occupant sitting on the rear seat enter the lower space USC of the vehicle seat 301 in the front row from behind, the entry detection sensor 360 detects the infrared ray emitted from the feet FTC as described above.

The acquisition unit 371 acquires the output signals of the entry detection sensor 360, the seat sensor 361, and the vehicle speed sensor 362. The determination unit 372 determines whether or not the feet FTC have entered the lower space USC from behind based on the detection signal of the entry detection sensor 360 acquired by the acquisition unit 371.

When the determination unit 372 determines that the feet FTC have entered the lower space USC from behind, the driving unit 373 drives the slide mechanism 350 so that the upper rail 351 slides forward relative to the lower rail 352 fixed to the floor FLC. Accordingly, the seat body 310 moves forward to be separated from the feet FTC entered from behind. As a result, since the foot space is expanded forward, the seated occupant sitting on the rear seat can take a released posture by using the expanded foot space.

The driving unit 373 may drive the slide mechanism 350 and rotate the rear link 342 to be upright. Accordingly, since the foot space can be expanded forward and upward, the seated occupant sitting on the rear seat can effectively use the expanded foot space.

The slide mechanism 350 may have any mechanism capable of sliding the seat body 310 in the front to rear direction relative to the floor FLC and may adopt a known electric slide mechanism. For example, the lower rail 352 fixed to the floor FLC has a screw member and the upper rail 351 fixed to the seat body 310 through the height adjustment mechanism 340 includes a motor and a gear member. The gear member meshes with the screw member to convert the rotational force of the motor into power for sliding in the front to rear direction. Accordingly, the upper rail 351 and the seat body 310 can be slid in the front to rear direction relative to the lower rail 352 by rotating the motor. The slide mechanism 350 corresponds to the sliding mechanism.

### Third Example

Next, a third example of the fourth embodiment will be described. In the above-described second example, it has been described that the vehicle seat 301 includes the height adjustment mechanism 340 and the slide mechanism 350. In contrast, the vehicle seat 301 according to the third example includes a rotation mechanism 355 which rotates and drives the seat body 310 about a rotation axis extending in the up to down direction and the seat body 310 is controlled to rotate by 45°. Accordingly, when the feet FTC of the seated occupant sitting on the rear seat enter the lower space USC from behind, the seat body 310 rotates to be separated from the feet FTC. Therefore, since the foot space in front of both feet FTC in the seat width direction is expanded forward, the seated occupant can effectively use the expanded foot space.

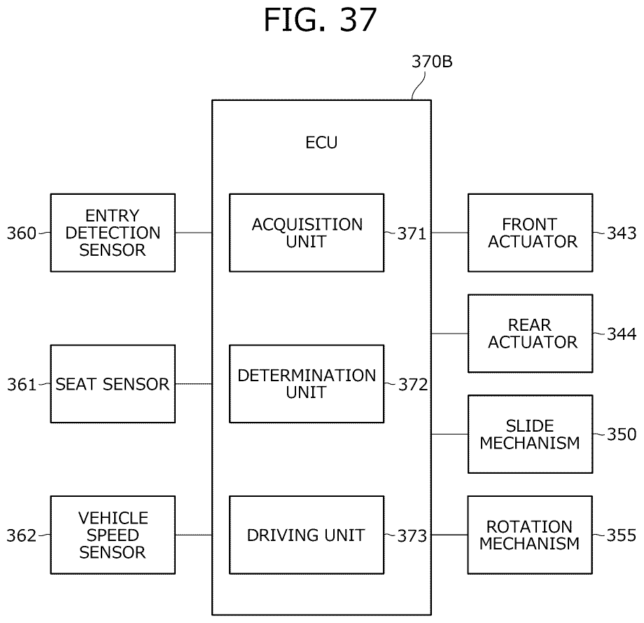

FIG. 37 is a block diagram showing the functional configuration of the vehicle seat 301 according to the third example. The vehicle seat 301 includes the entry detection sensor 360, the seat sensor 361, and a control device 370B which controls the rotation mechanism 355 based on the detection signal of the vehicle speed sensor 362.

The driving unit 373 drives at least one of the rear link 342 and the slide mechanism 350 when the determination unit 372 determines that the feet FTC have entered the lower space USC from behind. Accordingly, the seat body 310 moves to be separated from the feet FTC entered from behind. Further, the driving unit 373 drives the rotation mechanism 355 to rotate the seat body 310 by 45° about a rotation axis extending in the up to down direction. Therefore, it is possible to form a wide foot space in front of the right and left feet FTC of the seated occupant sitting on the rear seat. Then, the seated occupant sitting on the rear seat can effectively use the expanded foot space.

### Fourth Example

Next, a fourth example of the fourth embodiment will be described. In the above-described third example, it has been described that the vehicle seat 301 includes the non-contact entry detection sensor 360. In contrast, the vehicle seat 301 according to the fourth example includes a contact entry detection sensor 360A. By adopting the contact sensor, the seated occupant sitting on the rear seat can drive the seat body 310 of the vehicle seat 301 according to the own intension. Accordingly, the foot space can be effectively used and convenience can be improved.

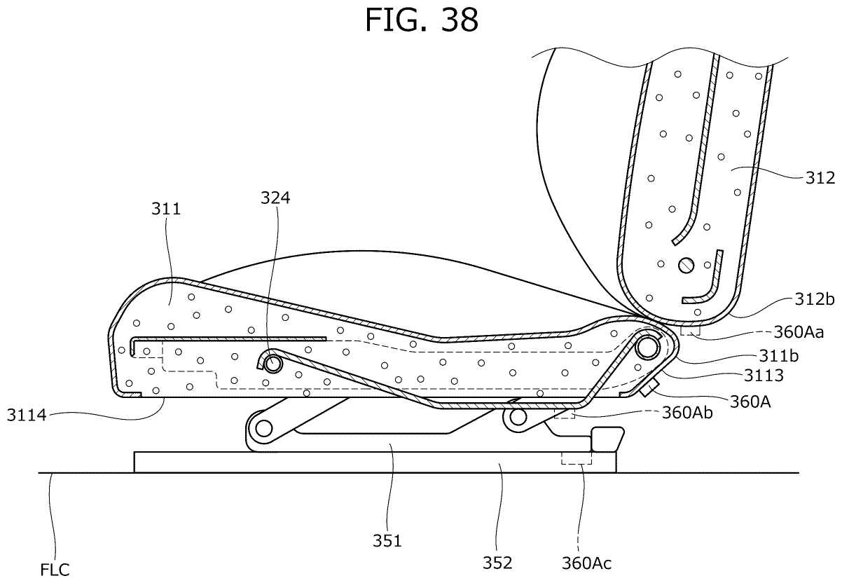

As shown in FIG. 38, the entry detection sensor 360A according to the fourth example is attached to the vicinity of the rear surface portion 3113 and the bottom surface portion 3114 of the seat cushion 311. Specifically, the entry detection sensor 360A is attached to the surface of the cover material 311b that covers the inclined portion 326c of the pressure receiving member 326 located in the vicinity of the rear surface portion 3113 and the bottom surface portion 3114 of the seat cushion 311.

The entry detection sensor 360A is a limit switch having an actuator. When the seated occupant sitting on the rear seat brings the feet FTC into contact with the actuator of the limit switch, the entry detection sensor 360 outputs a detection signal. Accordingly, the seat body 310 is controlled to be driven by the control device 370.

By disposing the entry detection sensor 360A on the rear surface portion 3113 of the seat cushion 311 in this way, it is possible to quickly detect when the feet FTC of the seated occupant sitting on the rear seat have entered the lower space USC from behind the vehicle seat 301.

Here, the entry detection sensor 360A may be disposed at a third attachment position 360Ab or a fourth attachment position 360Ac of FIG. 38. Then, the actuator of the limit switch preferably extends in the seat width direction of the vehicle seat 301. Accordingly, the seated occupant sitting on the rear seat can more simply expand the foot space just by stretching out the feet FTC so that the feet FTC come into contact with the actuator of the limit switch.

Further, the entry detection sensor 360A may be disposed at a second attachment position 360Aa of FIG. 38. Specifically, the entry detection sensor 360 may be attached to the surface of the cover material 312b at the lower end of the seat back 312. Then, the entry detection sensor 360A may be a capacitive touch sensor. In this case, when the seated occupant sitting on the rear seat stretches out his/her hand to the lower space USC from behind the vehicle seat 301 to touch the entry detection sensor 360, the entry detection sensor 360 outputs a detection signal. Accordingly, the control device 370 drives and controls the seat body 310 to expand the foot space.

As described above, it has been described that the control device 370 controls the drive mechanism so that the seat body 310 is separated from the entry object based on the output of the entry detection sensor 360, but the present invention is not limited thereto. The control device 370 may control the drive mechanism based on the operation of the operation switch operable by the seated occupant sitting on the rear seat. Accordingly, the foot space can be effectively used with great convenience.

It has been described that the entry detection sensor 360 detects the feet FTC of the seated occupant sitting on the rear seat, but the present invention is not limited thereto. For example, the entry detection sensor 360 may detect an object falling into the lower space USC from the side (the adjacent seat).

In the above-described embodiments, the vehicle seat 301 used in the automobile has been given as an example of the conveyance seat, but the present invention is not limited thereto. For example, the present invention can also be applied to other conveyance seats, such as seats used in ships and aircraft.

Further, the vehicle seats 101 to 101E of the second embodiment, the vehicle seat 201 of the third embodiment, and the vehicle seat 301 of the fourth embodiment can be applied to the vehicle seat 1 mounted on the vehicle of the first embodiment.

Appendices of the second embodiment to the fourth embodiment above will be described below.

### Second Embodiment

### (Appendix 1)

A conveyance seat disposed on a conveyance floor, including:
a seat cushion on which an occupant sits; and
an entry suppressing portion which is disposed between a region on a rear end side of the seat cushion and the floor and suppresses a foreign object from behind the conveyance seat from entering between the seat cushion and the floor.

### (Appendix 2)

The conveyance seat according to Appendix 1,
wherein the seat cushion includes a plate-shaped pressure receiving member that receives a load from the occupant, and
wherein the entry suppressing portion is formed by a protruding portion protruding from a back surface side of a rear end of the pressure receiving member toward the floor.

### (Appendix 3)

The conveyance seat according to Appendix 2,
wherein the protruding portion is formed by protruding the rear end of the pressure receiving member toward the floor.

### (Appendix 4)

The conveyance seat according to Appendix 2 or 3,
wherein the protruding portion is provided to avoid a harness engagement portion that engages with a harness arranged on the pressure receiving member.

### (Appendix 5)

The conveyance seat according to Appendix 1,
wherein the seat cushion includes a pad and a cushion side cover covering the pad, and
wherein the entry suppressing portion is formed by a bag-shaped portion formed at a rear portion of the cushion side cover.

### (Appendix 6)

The conveyance seat according to Appendix 1, further including:
a seat back which is connected to a rear portion of the seat cushion to provide a backrest for the occupant; and
a back pocket which is provided on a rear surface of the seat back,
wherein the back pocket has a surface portion that is rotatable about a lower end, and
wherein the entry suppressing portion is formed by the surface portion of the back pocket which rotates and has an upper end portion connected to the floor.

### (Appendix 7)

The conveyance seat according to Appendix 1, further including:
a seat back which is connected to a rear portion of the seat cushion to provide a backrest for the occupant,
wherein the seat back includes a pad and a back cover covering the pad, and
wherein the entry suppressing portion is formed by a hanging portion that hangs down from a lower end of the back cover.

### (Appendix 8)

The conveyance seat according to Appendix 1,
wherein the entry suppressing portion is formed by a protrusion protruding from the floor.

### (Appendix 9)

The conveyance seat according to Appendix 1,
wherein the seat cushion includes side covers on the right and left sides, and
wherein the entry suppressing portion is formed by a plate-shaped member that connects the rear end portions of the right and left side covers and extends toward the floor.

### Third Embodiment

### (Appendix 10)

A conveyance seat equipped with a seat cushion on which an occupant sits,
wherein the seat cushion includes a plate-shaped pressure receiving member that receives a load of the occupant and a harness member that is fixed to the pressure receiving member, and
wherein at least a part of the harness member is disposed in a center region in the right to left direction on the rear end side of the pressure receiving member.

### (Appendix 11)

The conveyance seat according to Appendix 10, further including:
a first harness engagement portion which engages the harness member with the pressure receiving member,
wherein the first harness engagement portion is disposed in a center region of the pressure receiving member in the right to left direction.

### (Appendix 12)

The conveyance seat according to Appendix 11, further including:
a seat back which is a backrest for the occupant,
wherein a back frame that constitutes a framework of the seat back includes a pair of right and left side frames, a lower frame which connects the lower parts of the pair of right and left side frames, and a second harness engagement portion which engages the harness member with the lower frame, and
wherein the second harness engagement portion is disposed in a center region of the lower frame in the right to left direction.

### (Appendix 13)

The conveyance seat according to Appendix 11 or 12,
wherein a concave portion is formed in a lower surface of the pressure receiving member to be recessed toward an upper surface side, and
wherein the first harness engagement portion is disposed in the concave portion and engages the harness member.

### (Appendix 14)

The conveyance seat according to Appendix 11 or 12,
wherein a wire is inserted into the center of the pressure receiving member, and
wherein the first harness engagement portion is disposed to avoid the wire.

### (Appendix 15)

The conveyance seat according to any one of Appendices 10 to 12, further including:
a buffer material provided at the rear end portion of the pressure receiving member and protecting the harness member.

### (Appendix 16)

The conveyance seat according to Appendix 15,
wherein the seat cushion includes a pad member disposed on the pressure receiving member, and
wherein the buffer material that protects the harness member is formed by a portion extending downward from the rear end of the pad member.

### (Appendix 17)

The conveyance seat according to any one of Appendices 10 to 12,
wherein the harness member is arranged on an upper surface side of the pressure receiving member.

### Fourth Embodiment

### (Appendix 18)

An electric conveyance seat including:
a seat body which is attached at a predetermined height position from a conveyance floor and forms a space between the seat body and the floor, a drive mechanism which drives the seat body to move, and control means for controlling the drive mechanism,
wherein the control means acquires a detection signal of an entry object entering the space and controls the drive mechanism so that the seat body is separated from the entry object based on the detection signal.

### (Appendix 19)

The conveyance seat according to Appendix 18,
wherein the drive mechanism is a lifting mechanism that drives the seat body in the up to down direction, and
wherein the control means controls the lifting mechanism to raise the seat body based on the detection signal.

### (Appendix 20)

The conveyance seat according to Appendix 19,
wherein the lifting mechanism includes a tiltable link member, and
wherein the control means controls the lifting mechanism to raise the link member based on the detection signal.

### (Appendix 21)

The conveyance seat according to Appendix 20,
wherein the link member includes a rear link member and a front link member, and
wherein the control means controls the lifting mechanism to raise the rear link member and tilt the seat body forward based on the detection signal.

### (Appendix 22)

The conveyance seat according to any one of Appendices 18 to 21,
wherein the drive mechanism is a sliding mechanism that drives the seat body back and forth, and
wherein the control means controls the sliding mechanism so that the seat body slides forward based on the detection signal.

### (Appendix 23)

The conveyance seat according to any one of Appendices 18 to 21,
wherein the drive mechanism is a rotation mechanism that rotates the seat body about a rotation axis extending in the up to down direction, and
wherein the control means controls the rotation mechanism so that the seat body rotates based on the detection signal.

### (Appendix 24)

The conveyance seat according to any one of Appendices 18 to 21,
wherein the control means acquires a seating signal related to a seated state of the occupant and controls the drive mechanism not to move the seat body based on the seating signal when the detection signal is acquired.

### (Appendix 25)

The conveyance seat according to any one of Appendices 18 to 21,
wherein the control means acquires a speed signal related to the conveyance speed and controls the drive mechanism not to move the seat body based on the speed signal when the detection signal is acquired.

### (Appendix 26)

The conveyance seat according to any one of Appendices 18 to 21,
wherein the conveyance seat includes a non-contact or contact entry detection sensor which detects the entry object and outputs the detection signal.

### (Appendix 27)

The conveyance seat according to any one of Appendices 18 to 21,
wherein the control means acquires an abnormality detection signal related to the presence or absence of an abnormality in the conveyance seat and controls the drive mechanism not to move the seat body based on the abnormality detection signal when the detection signal is acquired.

### REFERENCE SIGNS LIST

### First Embodiment

V: vehicle
FL: floor
FT: foot
2: vehicle compartment
3: vehicle body
4: wheel
5, 5A: cross member
6: floor panel
S1: front seat (first seat)
S2: middle seat (second seat)
S3: rear seat
1: vehicle seat
10: seat body
11: seat cushion
   11a: cushion pad (pad member)
   11b: cover material
12: seat back
   12a: back pad (pad member)
   12b: cover material
13: headrest
14: side cover
20: seat frame
21: seat cushion frame
22: cushion side frame
23: pan frame
24: front pipe
25: rear pipe
26: pressure receiving member
31: seat back frame (back frame)
32: back side frame
33: upper frame
34: lower frame
40: height adjustment mechanism
41: front link
42: rear link
50: slide mechanism
51: upper rail
52: lower rail
53: slide rail
   53a: front end
   53b: rear end
54: foot cover
   54a: inclined surface
60: reclining mechanism
70, 70A, 70B: concave portion
   71: front inclined surface
   72: rear inclined surface
   73: bottom surface
74: recess portion
75: opening portion
76: lid portion
77: shock absorbing member
78, 78A: footrest portion
78a: inclined surface
79A: inclined plate
R1, R2, R3: region
90: battery
91: battery plate
92: sub-cross member

### Second Embodiment

VA: vehicle
FLA: floor
ETA: foot
102: vehicle compartment
103: vehicle body
104: wheel
105, 105A: cross member
106: floor panel
S1A: front seat
S2A: middle seat
S3A: rear seat
101, 101′, 101A, 101B, 101C, 101D, 101E: vehicle seat
110: seat body
111: seat cushion
   111a: cushion pad
   111b: cover material
112: seat back
   112a: back pad
   112b: cover material
113: headrest
114: side cover
115: back pocket
116: plate-shaped member
120: seat frame
121: seat cushion frame
122: cushion side frame
123: pan frame
124: front pipe
125: rear pipe
126: pressure receiving member
127: protruding portion
131: seat back frame
132: back side frame
133: upper frame
134: lower frame
140: height adjustment mechanism
141: front link
142: rear link
150: slide mechanism
151: upper rail
152: lower rail
153: slide rail
160: reclining mechanism
170: harness member
171: harness clip (harness engagement portion)
R: region
180: entry suppressing portion
   180a: front end portion
   180b: rear end portion
   180c: bent portion
181: entry suppressing portion
   181c: bent portion
182: entry suppressing portion
   182a: bag-shaped portion
183: entry suppressing portion
   183a: top surface member
   183b: back surface member
   183c: attachment member
   183d: attachment member
   183e: lower end
184: entry suppressing portion
185: entry suppressing portion
186: entry suppressing portion
190: battery
191: battery plate
192: sub-cross member

### Third Embodiment

201: vehicle seat (conveyance seat)
210: seat body
211: seat cushion
   211a: cushion pad (pad member)
   211b: cover material
   2110: upper surface portion
   2111: front surface portion
   2112: side surface portion
   2113: rear surface portion
   2114: bottom surface portion
212: seat back
   212a: back pad (pad member)
   212b: cover material
213: headrest
220: seat frame
221: seat cushion frame
222: cushion side frame
223: pan frame
224: front pipe
225: rear pipe
226: pressure receiving member
   226a: concave portion
231: seat back frame (back frame)
232: back side frame
233: upper frame
234: lower frame
240: height adjustment mechanism
241: front link
241a: first swing shaft
241b: second swing shaft
242: rear link
242a: third swing shaft
242b: fourth swing shaft
250: slide mechanism
251: upper rail
252: lower rail
253: slide rail
254: foot cover
260: reclining mechanism
270: harness member
271: harness clip (first harness engagement portion)
272: harness clip (second harness engagement portion)
273: wire
274: buffer material
275: concave portion
276: rear end portion
277: groove-shaped concave portion
FLB: floor
FTB: foot
CAB, CA2B: center region

### Fourth Embodiment

301: vehicle seat
310: seat body
311: seat cushion
   311a: seat cushion pad
   311b: cover material
   3111: upper surface portion
   3112: side surface portion
   3113: rear surface portion
   4114: bottom surface portion
312: seat back
   312a: seat back pad
   312b: cover material
313: headrest
320: vehicle seat frame
321: seat cushion frame
322: cushion side frame
323: pan frame
324: front pipe
325: rear pipe
326: pressure receiving member
   326a: pressure receiving plate
   326b: elastic spring
   326c: inclined portion
331: seat back frame
332: back side frame
333: upper frame
334: lower frame
335: horizontal connection frame
336: pillar attachment member
340: height adjustment mechanism (drive mechanism)
341: front link (front link member)
   341a: first swing shaft
   341b: second swing shaft
342: rear link (rear link member)
342a: third swing shaft
342b: fourth swing shaft
343: front actuator
344: rear actuator
350: slide mechanism (drive mechanism)
351: upper rail
352: lower rail
355: rotation mechanism
360, 360A: entry detection sensor
   360a, 360Aa: second attachment position
   360b, 360Ab: third attachment position
   360c, 360Ac: fourth attachment position
361: seat sensor
362: vehicle speed sensor
370, 370A, 370B: control device
371: acquisition unit
372: determination unit
373: driving unit
USC: lower space
FTC: foot
VC: vehicle
FLC: floor
BTC: secondary battery

1. A vehicle equipped with a floor, a first seat disposed on the floor, and a second seat disposed behind the first seat, comprising:
a concave portion which is formed in the floor to include at least a region located behind the first seat and to place feet of a seated occupant sitting on the second seat.

2. The vehicle according to claim 1,
wherein the concave portion has a triangular cross section.

3. The vehicle according to claim 1, further comprising:
a pair of slide rails which are attached so that the first seat is slidable on the floor,
wherein the concave portion is formed at a position behind rear ends of the pair of slide rails.

4. The vehicle according to claim 1, further comprising:
a pair of slide rails which are attached so that the first seat is slidable on the floor,
wherein the concave portion is formed between the pair of slide rails to include a region located in front of rear ends of the pair of slide rails.

5. The vehicle according to claim 1, further comprising:
a pair of slide rails which are attached so that the first seat is slidable on the floor,
wherein the concave portion is formed between the pair of slide rails to include a region continuously extending from the front to the rear of the pair of slide rails.

6. The vehicle according to claim 1, further comprising:
a beam member that extends in a right to left direction of the vehicle below the floor and supports the floor,
wherein the concave portion is formed at a position avoiding the beam member.

7. The vehicle according to claim 1, further comprising:
a beam member that extends in a right to left direction of the vehicle on the floor and supports the floor,
wherein the concave portion is formed at a position avoiding the beam member.

8. The vehicle according to claim 1,
wherein the floor has an opening portion formed in a region located below the first seat,
wherein the floor has a lid portion that closes the opening portion, and
wherein the concave portion is formed at a position avoiding the lid portion.

9. The vehicle according to claim 1, further comprising:
a battery which is disposed below the floor; and
a member that is disposed on the battery between the floor and the battery,
wherein the concave portion is formed at a position avoiding a member disposed on the battery.

10. The vehicle according to claim 3,
wherein a foot cover is provided at each of rear ends of the pair of slide rails of the first seat, and
wherein the foot cover has an inclined surface inclined downward as it goes toward the rear of the vehicle.

11. The vehicle according to claim 10,
wherein the foot cover is integrally formed across the rear ends of the pair of slide rails, and
wherein the inclined surface of the foot cover extends to the concave portion formed in the floor.

12. The vehicle according to claim 1,
wherein the first seat includes a seat cushion on which an occupant sits and an entry suppressing portion which is disposed between a region on a rear end side of the seat cushion and the floor and suppresses a foreign object from behind the first seat from entering between the seat cushion and the floor.

13. The vehicle according to claim 1,
wherein the first seat is a conveyance seat equipped with a seat cushion on which an occupant sits,
wherein the seat cushion includes a plate-shaped pressure receiving member that receives a load of the occupant and a harness member that is fixed to the pressure receiving member, and
wherein at least a part of the harness member is disposed in a center region in a right to left direction on a rear end side of the pressure receiving member.

14. The vehicle according to claim 1,
wherein the first seat is an electric conveyance seat including a seat body attached at a predetermined height position from the conveyance floor and forming a space between the seat body and the floor, a drive mechanism driving the seat body to move, and control means controlling the drive mechanism, and
wherein the control means acquires a detection signal of an entry object entering the space and controls the drive mechanism so that the seat body is separated from the entry object based on the detection signal.
